(19) United States
(12) Patent Application Publication
(10) Pub. No.: US 2025/0260470 A1
(43) Pub. Date: Aug. 14, 2025

(54) ZERO OUTAGE BEAM FAILURE RECOVERY AND MOBILITY PROCEDURES FOR HIGHLY DIRECTIONAL SYSTEMS

(71) Applicant: InterDigital Patent Holdings, Inc., Wilmington, DE (US)

(72) Inventors: Umer Salim, Vallauris (FR); Sanjay Goyal, Deer Park, NY (US); Pascal Adjakple, Great Neck, NY (US); Ravikumar Pragada, Warrington, PA (US)

(73) Assignee: InterDigital Patent Holdings, Inc., Wilmington, DE (US)

(21) Appl. No.: 18/851,350

(22) PCT Filed: Apr. 25, 2023
(86) PCT No.: PCT/US23/19727

§ 371 Date: Sep. 26, 2024

(51) Int. Cl. H04B 7/06; G01S 19/39; H04W 74/0833

(52) U.S. Cl. CPC H04B 7/06964; G01S 19/39; H04B 7/0626; H04W 74/0833

(57) ABSTRACT

Beam failure recovery and conditional handover may utilize deployment information regarding cells/beams. A wireless transmit/receive unit (WTRU) may receive a beam recovery configuration. The beam recovery configuration may include an indication of candidate recovery beams, network deployment information, information regarding areas of coverage of the candidate recovery beams, at least one quality criterion, random access channel (RACH) parameters, or any appropriate combination thereof. The WTRU may detect a beam failure. The WTRU may select a recovery beam from the candidate recovery beams based on the beam failure and the beam recovery configuration.

### CROSS REFERENCE TO RELATED APPLICATIONS

This application claims the benefit of U.S. Provisional Patent Application No. 63/335,462, filed Apr. 27, 2022. U.S. Provisional Application No. 63/335,462 is incorporated herein by reference in its entirety.

### BACKGROUND

As cellular networks are planned networks, the network may have very precise knowledge of its deployment of cells, and the beams within those cells. What a network may not know is how a specific device will move from one cell/beam to another cell/beam. This information is in general may not be known to a device itself. In general, a device may have no information about network deployment in terms of cells and beams and the geographic areas where these cells/beams are active.

### SUMMARY

Described herein are example methods and systems for beam failure recovery and conditional handover with minimal outage and interruption. In example embodiments, known deployment information regarding cells/beams from the networks may be utilized. A network may provide a finite snapshot of network deployment information to a device along with suitable coordinates binding the cells/beams to geographic locations and orientations. A device may use the information from local sensors and interfaces to extract its current geographic parameters and use this information to determine a suitable candidate beam for a beam recovery procedure and suitable cells for a conditional handover. As explained herein, a device may comprise a user equipment (UE), a wireless transmit/receive unit (WTRU), or the like. The terms UE and WTRU are used interchangeably herein.

An example zero outage beam failure recovery procedure may comprise the following. A WTRU may provide assistance information to the network about position/location/panels/field of view (FoV)/Application-quality of service (QoS) from local sensors and measurement data. The next generation node B (gNB) may prepare the zero outage beam recovery configuration in response to the WTRU assistance information combined with its knowledge of network deployment and transmit this to WTRU. The zero outage beam recovery configuration may comprise a set of candidate beams for recovery and the mapping of these candidate beams to suitable active zones (position/location, angular span, WTRU Panel) where these beams may be activated with zero outage. After a beam failure event, the WTRU may extract the information from local sensors and measurement data to compute its updated geographic coordinates and orientation. The WTRU may identify the suitable beam recovery candidate according to its determined coordinates/orientation. The WTRU may derive random access channel (RACH) parameters for the selected recovery candidate and may perform RACH transmission as part of the beam recovery procedure on the selected candidate beam.

An example zero outage conditional handover procedure may comprise the following. A WTRU may provide assistance information to the network about position/location/panels/FoV/Application-QoS from local sensors and measurement data. The gNB may prepare the zero outage conditional handover configuration in response to the WTRU assistance information combined with its knowledge of network deployment and transmit this to WTRU. The zero-outage conditional handover configuration may comprise a set of candidate cells. For each cell, relevant beam indices may be provided. For each (cell, beam) pair, the mapping of the (cell, beam) pair to suitable geographic coordinates (position/location, angular span, UE Panel) may be provided as part of the configuration. After a mobility event (resulting from device mobility or mobility in the environment) leading to compromised link quality, the WTRU may use the information from local sensors and configured thresholds to compute its updated geographic coordinates and orientation. The WTRU may derive the highest priority (cell, beam) pair from the network configured mapping against its estimated geographical coordinates. The WTRU may evaluate the CHO execution condition for the determined (cell, beam) pair. If conditional handover (CHO) conditions get fulfilled, the WTRU may perform conditional handover to the determined (cell, beam) by transmitting RACH for the candidate (cell, beam) pair according to the configured parameters.

An example WTRU configured to perform beam failure recovery may comprise a processor and a transceiver. The WTRU may be configured to receive, via the transceiver, a beam recovery configuration. The beam recovery configuration may comprise an indication of at least one candidate beam, respective reference signal information associated with each candidate beam of the at least one candidate beam, respective information associated with each candidate beam of the at least one candidate beam, or any appropriate combination thereof. The information associated with each candidate beam may comprise an indication of at least one area of coverage associated with a respective candidate beam of the at least one candidate beam. The WTRU may be configured to detect a beam failure condition. The WTRU may be configured to select at least one candidate beam of the at least one candidate beam at least based on the beam failure condition, local sensor data, and the respective area of coverage associated with the selected at least one candidate beam. The WTRU may be configured to send configuration information associated with the selected at least one candidate beam. The WTRU may be configured to send an indication that the WTRU is capable of using the local sensor data for beam failure recovery The beam recovery configuration may comprise a priority associated with each candidate beam of the at least one candidate beam. The WTRU may be configured to select the at least one candidate beam based on the priority associated with each candidate beam of the at least one candidate beam. The WTRU may be configured to select the at least one candidate beam based on the respective reference signal information associated with each candidate beam of the at least one candidate beam. The reference signal information may comprise primary synchronization sequence, secondary synchronization sequence, synchronization sequence block, channel state information reference signal information, random access channel information, or any appropriate combination thereof. The information associated with each candidate beam may comprise global positioning system information, gyroscopic information, accelerometer information, or any appropriate combination thereof. The information associated with each candidate beam may comprise respective geographical information for each candidate beam, respective angular information for each candidate beam, respective range information for each candidate beam, respective orientation information for each candidate beam, respective beam- width information for each candidate beam, or any appropriate combination thereof. The received recovery configuration may include at least one quality criterion associated with each candidate beam. The received recovery configuration may include random access channel (RACH) parameters. The WTRU may be configured to select the at least one candidate beam based on meeting the respective at least one quality criterion. The configuration information associated with the selected at least one candidate beam may be in accordance with the respective RACH parameters.

An example method for performing beam failure recovery may comprise receiving a beam recovery configuration. The beam recovery configuration may comprise an indication of at least one candidate beam, respective reference signal information associated with each candidate beam of the at least one candidate beam, respective information associated with each candidate beam of the at least one candidate beam, or any appropriate combination thereof. The information associated with each candidate beam may comprise an indication of at least one area of coverage associated with a respective candidate beam of the at least one candidate beam. The method may comprise detecting a beam failure condition. The method may include sending configuration information associated with the selected at least one candidate beam. At least one candidate beam of the at least one candidate beam may be selected based on the beam failure condition, local sensor data, and the respective area of coverage associated with the selected at least one candidate beam. An indication that a WTRU is capable of using the local sensor data for beam failure recovery may be sent. The beam recovery configuration may comprise a priority associated with each candidate beam of the at least one candidate beam. Selecting the at least one candidate beam may be based on the priority associated with each candidate beam of the at least one candidate beam. Selecting the at least one candidate beam may be based on the respective reference signal information associated with each candidate beam of the at least one candidate beam. The reference signal information may comprise primary synchronization sequence, secondary synchronization sequence, synchronization sequence block, channel state information reference signal information, random access channel information, or any appropriate combination thereof. The information associated with each candidate beam may comprise global positioning system information, gyroscopic information, accelerometer information, or any appropriate combination thereof. The information associated with each candidate beam may comprise respective geographical information for each candidate beam, respective angular information for each candidate beam, respective range information for each candidate beam, respective orientation information for each candidate beam, respective beam-width information for each candidate beam, or any appropriate combination thereof. The received recovery configuration may include at least one quality criterion associated with each candidate beam. The received recovery configuration may include RACH parameters. The method may include selecting the at least one candidate beam based on meeting the respective at least one quality criterion. The configuration information associated with the selected at least one candidate beam may be in accordance with the respective RACH parameters.

An example computer-readable storage medium may have executable instructions stored thereon that when executed by a processor, cause the processer to be configured to facilitate beam failure recovery. A WTRU may comprise the processor. When the executable instructions are executed, the processor may be configured to receive a beam recovery configuration. The beam recovery configuration may comprise an indication of at least one candidate beam, respective reference signal information associated with each candidate beam of the at least one candidate beam, respective information associated with each candidate beam of the at least one candidate beam, or any appropriate combination thereof. The information associated with each candidate beam may comprise an indication of at least one area of coverage associated with a respective candidate beam of the at least one candidate beam. When the executable instructions are executed, the processor may be configured to detect a beam failure condition. When the executable instructions are executed, the processor may be configured to select at least one candidate beam of the at least one candidate beam based on the beam failure condition, local sensor data, and the respective area of coverage associated with the selected at least one candidate beam. When the executable instructions are executed, the processor may be configured to send configuration information associated with the selected at least one candidate beam. When the executable instructions are executed, the processor may be configured to send an indication that a WTRU is capable of using the local sensor data for beam failure recovery. The beam recovery configuration may comprise a priority associated with each candidate beam of the at least one candidate beam. When the executable instructions are executed, the processor may be configured to select the at least one candidate beam based on the priority associated with each candidate beam of the at least one candidate beam. When the executable instructions are executed, the processor may be configured to select the at least one candidate beam based on the respective reference signal information associated with each candidate beam of the at least one candidate beam. The reference signal information may comprise channel state information reference signal information, random access channel information, or any appropriate combination thereof. The information associated with each candidate beam may comprise global positioning system information, gyroscopic information, accelerometer information, or any appropriate combination thereof. The information associated with each candidate beam may comprise respective geographical information for each candidate beam, respective angular information for each candidate beam, respective range information for each candidate beam, respective orientation information for each candidate beam, respective beam-width information for each candidate beam, or any appropriate combination thereof. The received recovery configuration may include at least one quality criterion associated with each candidate beam. The received recovery configuration may include RACH parameters. When the executable instructions are executed, the processor may be configured to select the at least one candidate beam based on meeting the respective at least one quality criterion. The configuration information associated with the selected at least one candidate beam may be in accordance with the respective RACH parameters.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 is an example illustration of a timing diagram of WTRU attach procedure.

FIG. 3 is an example illustration of beam failure detection at the medium access control (MAC) layer.

FIG. 4 is an example illustration of parallel running procedures for beam/cell level mobility.

FIG. 5 is an example illustration of intra-NR (new radio) inter-gNB handover.

FIG. 6 is an example illustration of intra-NR RAN (radio access network) conditional handover.

FIG. 7 is an example illustration of cell coverage with different gain beams.

FIG. 8 is an example illustration of link budget analysis showing the number of beams and antennas elements required at different carrier frequencies.

FIG. 9 is an example illustration of ultra-massive MIMO (multiple input multiple output) update beam switch and mobility procedures.

FIG. 10 is an example illustration of mobility resulting from WTRU rotation/orientation.

FIG. 11 is an example illustration of beam span configurations.

FIG. 12 is an example flow chart for zero outage beam failure recovery with separate device/external mobility configurations.

FIG. 13 is an example flow chart for zero outage beam failure recovery with unified configuration.

FIG. 14 is an example illustration of a beam failure recovery solution in translational motion scenario.

FIG. 15 is an example illustration of a zero outage configuration for conditional handover (rotation focus).

FIG. 16 is an example illustration of a zero outage configuration of conditional handover—translational and rotation.

FIG. 17 is an example illustration of a zero outage beam recovery and conditional handover configuration.

FIG. 18 is an example flowchart for zero outage conditional handover with device and external mobility configurations.

FIG. 19 is an example flowchart for zero outage conditional handover with unified mobility configurations.

FIG. 20A and FIG. 20B depict an example flowchart for a WTRU configured with zero outage BFR (beam failure recovery) and zero outage CHO (conditional handover) configurations.

### EXAMPLE NETWORKS FOR IMPLEMENTATION OF THE INVENTION

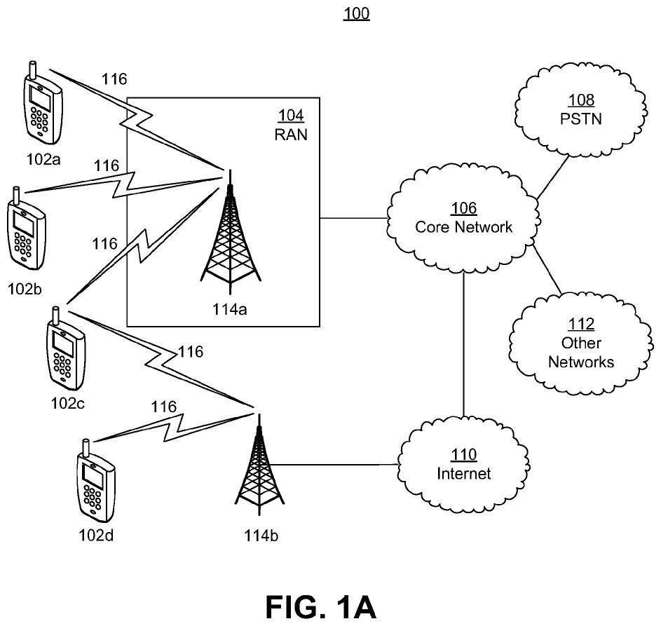

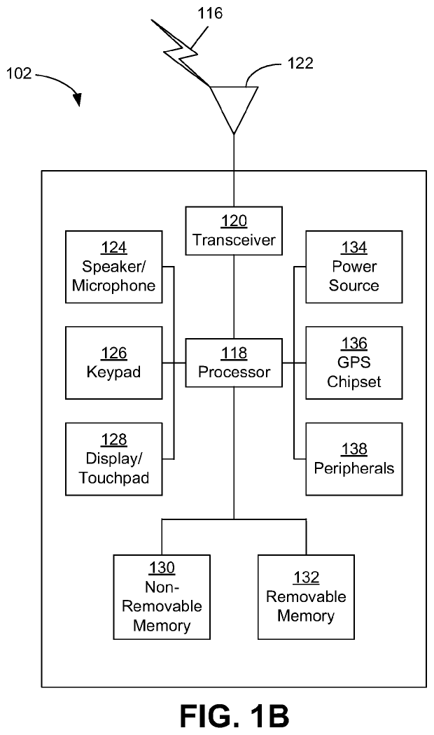

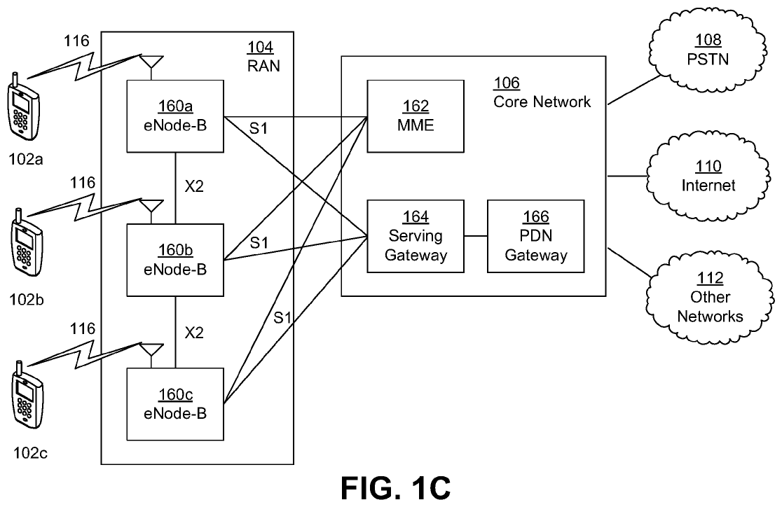

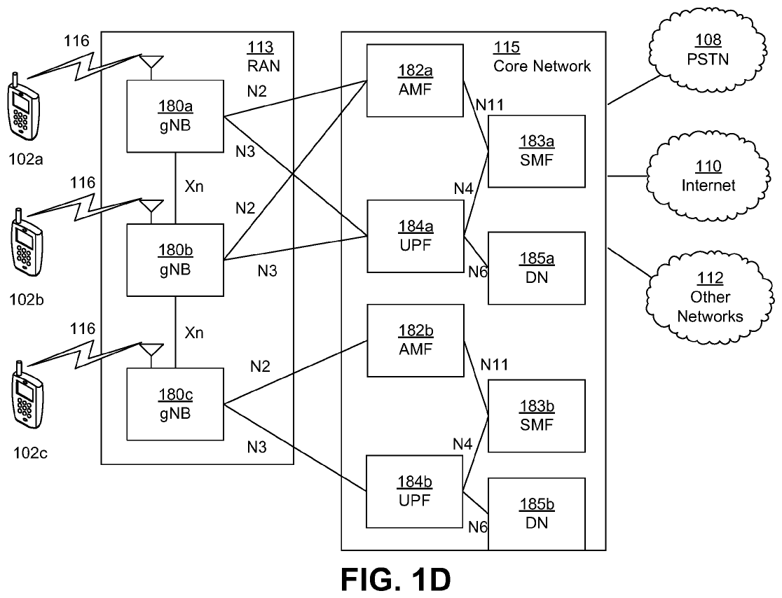

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Wireless communication between one or more user equipments (UEs) and a network is considered herein. A WTRU may also be referred to as a wireless transmit/receive unit (WTRU). The terms UE and WTRU are used interchangeably herein.

5G NR (new radio) beam-based procedures are described herein. A feature of the 5G-New Radio (NR) design may be its ability to operate in two different frequency ranges: sub-6 GHz which is called frequency range 1 (FR1) and millimeter wave (mm Wave) termed as frequency range 2 (FR2). As the availability of sub-6 GHz range becomes more limited, mm Wave frequency bands with wider bandwidths may become more predominant. This change led to the extension of FR2 range to 71 GHz in 3GPP Release-17, and the extended range between 51.4 GHz to 71 GHz is termed as FR2-2.

3GPP 5G NR standards may define new Physical Layer (PHY) and Medium Access Control (MAC) layer features to support directional communications. Beam management, which is used to acquire and maintain beams, may be among the features. 3GPP 5G NR may also define new initial access procedures to ensure successful directional transmission. As the transmission and reception are happening through narrow beams, there may be procedures to detect beam failure and to recover from beam failure. Beam management may comprise a set of Layer 1 (PHY) and Layer 2 (MAC) procedures to establish and retain an optimal beam pair for good connectivity. A beam pair may comprise a transmit beam and a corresponding receive beam in one link direction.

Before a WTRU can communicate with the network, the WTRU may perform cell search and selection procedures and obtain initial cell synchronization and system information. The first step in that process may be acquiring frame synchronization, finding out the cell identity and decoding the MIB (master information block) and SIB1 (system information block 1).

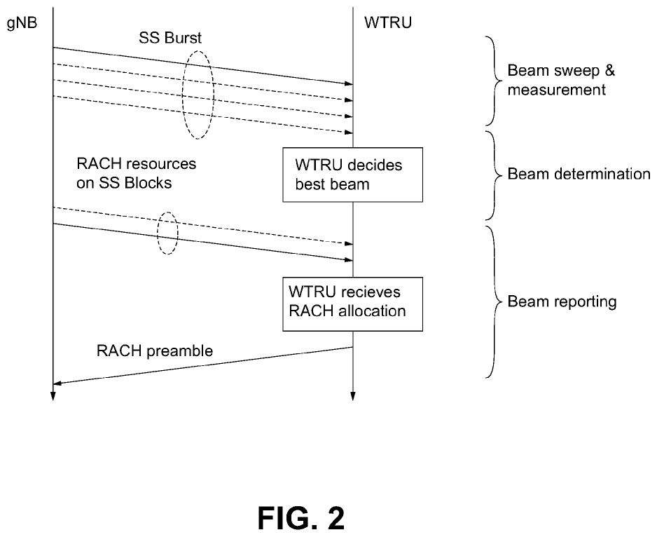

In the case of a multi-antenna system that transmits multiple beams, detecting the beams from gNB may be also a part of the initial access procedure where the WTRU normally detects all the beams in the search space. FIG. 2 shows an example timing diagram for the WTRU attach procedure, which may include various aspects of beam management. A WTRU may first find a suitable beam, decode necessary system information through this beam, and then initiate uplink (UL) connection using the received parameters.

Beam sweeping and initial access procedures may be performed. A gNB may transmit beams in all directions in a burst at regular defined intervals. Whenever a WTRU is synchronizing with the network, it may read the synchronization signal block (SSB) and extract the signals. The signals may include primary synchronization signal (PSS), secondary synchronization signal (SSS), and/or physical broadcast channel (PBCH) and demodulation reference signal (DMRS). The PSS, for example, may include one of three possible sequences and/or provide time estimate. The SSS, for example, may include one of 336 possible sequences and/or provide cell ID (one of 3*336=1008). The PBCH and DMRS may, for example, contain master information block (MIB) and/or include basic information to take the next step, which is to decode the system information block (SIB)−1.

The WTRU may perform beam measurement and determination. The WTRU may measure the beam strength by measuring received signal power through a beam. In idle mode the measurement may be based on the synchronization signals, and in connected mode it is based on the channel state information reference signal (CSI-RS) in downlink and sounding reference signal (SRS) in uplink. A WTRU may search for the best beam periodically using the predefined threshold criteria defined by the gNB and identify the beam that has highest reference signal received power (RSRP).

In a process called beam reporting, the best beam identified by the WTRU may be informed to the gNB. A random access channel (RACH) may be an uplink channel used during initial access or when the WTRU is out of sync with the network and needs to establish synchronization. In idle mode, after the WTRU has selected the beam, there may be one or more RACH intervals for the WTRU with a certain time and frequency offset, during which the WTRU may transmit the RACH preamble. The WTRU may transmit the physical RACH (PRACH) preamble corresponding to the SS block (synchronization signal block) for which the best beam was identified. There may be a one-to-one mapping between the received SS block and the transmitted RACH preamble. This may be a way for the WTRU to report the best beam to the gNB as the gNB upon receiving RACH in a given interval can back-calculate the best beam through which a WTRU might have received the best synchronization signals.

The process that the network configures the WTRU to perform certain measurements and report them on a preconfigured interval may be called measurement reporting. In connected mode, when the WTRU is already connected with the gNB and active data transfer is taking place, the WTRU may report the beam through a measurement report to gNB.

The WTRU may perform beam switching. Switching from one beam to another may be called intra-cell mobility or beam-level mobility. The WTRU may perform beam switching based on a trigger condition for a beam and a configured beam switching algorithm. For example, the WTRU may be in connected mode and perform beam switching through L1/L2 procedures. On the other hand, the WTRU may typically use handover for inter-cell mobility through an L3 procedure.

Described herein are 3GPP procedures for detecting beam failure (recovery) and radio link failure. In an example embodiment, the WTRU may perform beam failure detection and recovery (BFDR). When the WTRU and the gNB are communicating through narrow beams, the WTRU mobility and the changes in the environment may lead to deterioration of the beam pair. Beam level measurements and continuous evaluation may be procedures which help maintain and switch to the best beam pair between the WTRU and the gNB. These procedures may be jointly called beam failure detection and recovery (BFDR).

When the quality of a beam deteriorates, PHY layer of a WTRU may generate a “Beam Failure Instance (BFI)” when the measurements from the configured reference signals for this beam fall below a configured threshold. The MAC layer may maintain a “Beam Failure Instance Counter”. The MAC layer may increment the BFI counter and reset the “Beam Failure Detection Timer” for each instance of the PHY layer reporting BFI. If the BFI counter exceeds a configured value, a beam failure may be detected. Beam failure detection (BFD) may happen within the Beam Failure Detection Timer.

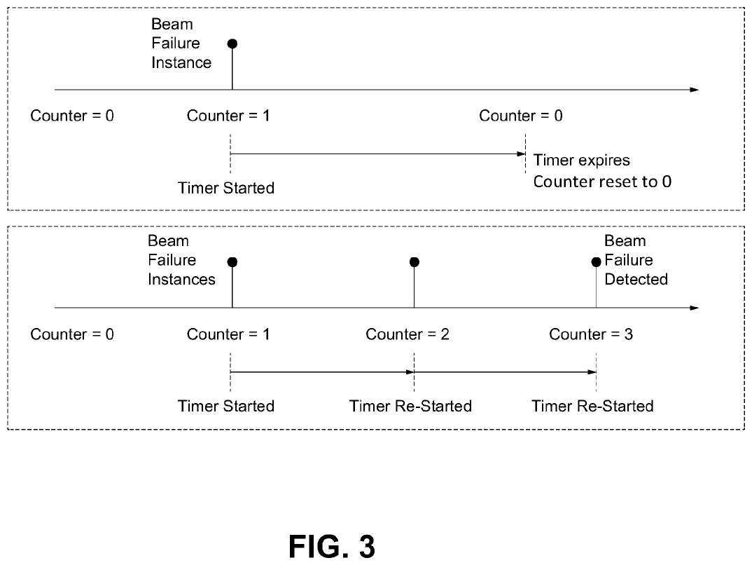

FIG. 3 shows two example situations with beam failure procedure. In one example, the upper sub-figure may show the case when the MAC layer receivers a BFI from the PHY layer, no beam failure is generated because the timer expires. In another example, the lower sub-figure may show the case where the PHY Layer is reporting BFI at a rate which are not letting the timer expire and BFI counter reaches the BFD threshold, and the MAC layer will generate BFD.

After the detection of beam failure event, the WTRU may initiate a beam failure recovery (BFR) process. Once beam failure has been detected, the WTRU may try to recover from the beam failure if the candidate beams are configured. The WTRU may try to validate the configured candidates for a given serving cell according to the configured/defined measurement quality criterion and thresholds. The WTRU may prepare a BFR MAC-CE or a truncated BFR MAC-CE according to defined conditions where the cells and recovery beams are indicated for network knowledge.

The actual beam recovery procedure may differ depending upon whether the beam failure is detected on the SpCell (special cell) or on an SCell (secondary cell). For beam recovery procedure on an SpCell, after validating the configured candidate beams, the WTRU may choose a suitable validated candidate beam for RACH transmission. The WTRU may send normal or truncated BFR MAC-CE as part of the RACH procedure. RACH transmission may follow the parameters configured as part of the candidate beam configuration. A successful RACH transmission may let the network know that the WTRU has recovered through this candidate beam. For beam recovery procedure on an SCell, after having validated the candidate beams, the WTRU may transmit the BFR MAC-CE or truncated BFR MAC-CE to the network. The WTRU may not initiate a RACH procedure for beam failure recovery on an SCell.

In one embodiment, the WTRU may perform radio link failure procedures. The WTRU may perform radio link monitoring (RLM) based on the synchronization signal block (SSB) or/and the channel state information reference signals (CSI-RS), and the signal quality thresholds configured by the network. The PHY layer at the WTRU may make the measurements and pass them on to the MAC and the RRC layers. The MAC layer may be responsible for detecting beam failures, while the RRC layer may be responsible for detecting Radio Link Failure (RLF). The network may use RRC signaling to configure the WTRU with the RLM reference signals (RLM-RS) and the associated thresholds. RLM-RS can be SSB, or CSI-RS or a combination of the two. The network may configure the timers to be used for RLF detection/determination as part of the primary cell configuration. The PHY layer may generate an “Out-of-sync (OOS)” indication when the radio link quality belonging to all of the monitored RS is worse than the configured threshold. The PHY layer may generate an “In-Sync” indication when the radio link quality belonging to at least one of the monitored RS is better than a configured threshold. The In-Sync and OOS indications may be passed to the RRC layer.

Example criteria to declare RLF may include (1) T310 based RLF, (2) T312 based RLF, (3) random access procedure failure, (4) failure in Beam Failure Recovery procedure, and (5) RLF due to maximum number of re-transmissions from radio link control (RLC) layer. In one embodiment, T310 based RLF may base on the link quality measurements (using SSBs or/and CSI-RSs). If consecutive out-of-sync indications (e.g., measurement is below the given threshold) are received a preset number of times, N310 times, the RLF timer T310 may start. If the channel quality recovers before the T310 timer expires, the T310 timer may reset; otherwise, upon expiration of the T310 timer, a RLF may be declared. In another embodiment, T312 based RLF may include that the WTRU starts the T312 timer upon triggering a measurement report for which the T310 timer is already running. The T312 timer may allow the WTRU to differentiate between an RLF caused by a handover failure or an RLF caused by coverage hole. The T312 timer may be typically shorter than the T310 timer. Thus, if the channel quality of the source gNB is worse than a threshold, the shorter T312 timer may expire earlier and a RLF may be timely declared. In another embodiment, the random access procedure failure may include that a RLF is declared if multiple RACH attempts to connect to a gNB fail consecutively. In another embodiment, the failure in Beam Failure Recovery procedure may include a failure in recovering to a suitable beam after detecting beam failure leads to an indication of link failure.

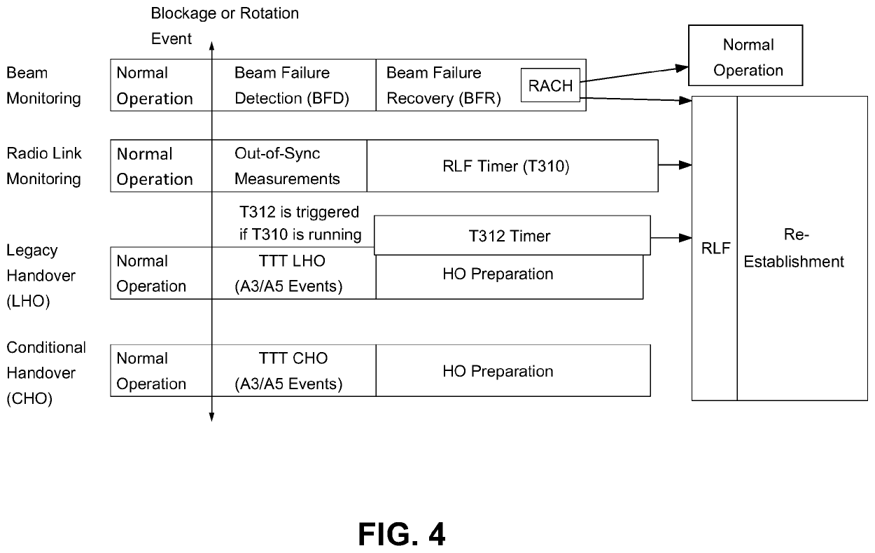

When the beams and links are deteriorating, the BFDR, RLM, and handover procedures may run concurrently, as illustrated in FIG. 4. Each individual procedure may lead to an RLF. When the WTRU is configured to use legacy handover (HO), the link outage may interrupt the measurement reporting and/or HO initiation. Thus, the HO operation may fail. In parallel, the BFDR procedure may attempt to recover through BFR. If the recovery attempts fail, the BFDR procedure may declare an RLF. When the WTRU is configured to use conditional handover (CHO), for example, once the serving link starts to degrade, the WTRU may evaluate the execution condition for the conditional handover and may handover to the target cell if the execution condition is satisfied.

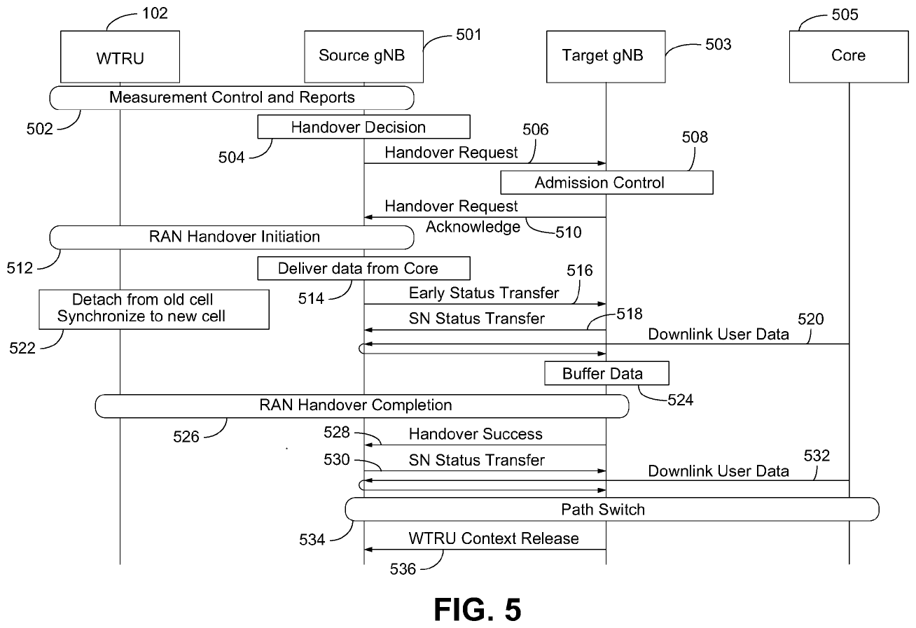

FIG. 5 illustrates an example depiction of intra-NR inter-gNB handover. NR-cell level mobility procedures may be performed as depicted in FIG. 5. In the following description NR inter-gNB handover also may be referred to as a legacy handover. When WTRU 102 is in RRC connected mode, cell/gNB level mobility may require explicit RRC signaling to be triggered. WTRU 102 may report (502) the cell quality measurement to its serving (source) cell (e.g., Source gNB 501) when, a neighboring cell quality is offset better for a preset duration of time-to-trigger (TTT). Different events called A1, A2, A3, A4, A5, etc. may be defined for WTRU measurement report triggering. The TTT and the cell specific offsets may be specified during the measurement configuration step. If a handover (HO) decision 504 is made based on measurement report (502), source gNB 501 may issue a handover request (506) to target gNB 503. If WTRU 102 is admitted (508) by target gNB 503, target gNB 503 may send a handover request acknowledgement (510) to source gNB 501, which may contain an RRC message to be sent to WTRU 102. Next, source gNB 501 may initiate handover (512) and may send the RRC Reconfiguration message to WTRU 102. The RRC Reconfiguration message may include a set of dedicated RACH resources. Source gNB may keep the functionality of delivering (514) the data from the core network to the WTRU through target gNB. Source gNB may send the early status of sequence numbers to target gNB (518) and target gNB may send confirmation (518). After this step, source gNB may start to transfer downlink (520) data for WTRU to target gNB which is buffered at target gNB (524). Finally, the WTRU 102 may synchronize to the target cell (522) and complete the RRC handover procedure (526). Target gNB may inform the HO success to source gNB (528) and source gNB may transfer the sequence number status to target gNB (530). Source gNB may be providing DL data to target gNB (532) until path switch happens with the core network (534). Target gNB may send the message of WTRU context release to source gNB (536) after the path switch.

The HO process may fail due to poor channel qualities of the target gNB, the source gNB or both. In a scenario with directional links, handover problems may be exacerbated because the link qualities of the target and source gNBs may suddenly deteriorate due to mobile blockers or WTRU rotations. First, the blockage of target gNB during a handover procedure may result in a handover failure (HOF). When the WTRU receives RRC Reconfiguration message, a handover failure timer T304 may start. If the T304 timer expires before the handover is completed, a HOF may be declared, and the WTRU may perform connection re-establishment. Second, after a sudden WTRU rotation or a blockage, the source gNB may not be able to initiate a handover procedure in time based on the most recent measurement reports. Even the measurement reports from the WTRU may be lost due to poor link quality. Thus, without handover assistance from the source gNB, even when there are potential target gNBs with good channel qualities, the WTRU may need to either wait for the source gNB to recover from outage or declare an RLF.

Dual-active protocol stack (DAPS) handover may be performed. As a potential solution to the target gNB being blocked, dual-active protocol stack (DAPS) handover may be performed. In DAPS handover, the WTRU may not release the source cell connection until random access to the target gNB is completed. If the target gNB link deteriorates before random access is completed, the WTRU may fall back to the source gNB.

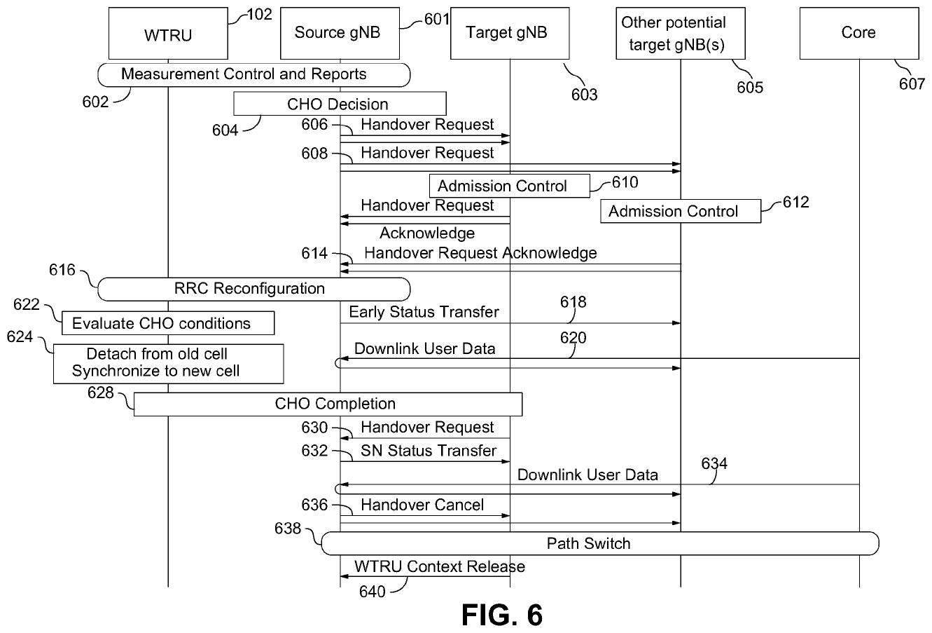

FIG. 6 is an example illustration of intra-NR RAN conditional handover. Conditional handover (CHO) may be performed as depicted in FIG. 6. To address the blockage of the source gNB, conditional handover (CHO) may be performed. In CHO, the WTRU may be configured to execute handover when one or more handover execution conditions are met. The source gNB may proactively configure the WTRU to evaluate CHO execution conditions defined for candidate gNBs. Once the conditions are met, e.g., when the target gNB is an offset better than the source gNB, the WTRU may initiate handover to a target gNB without the signaling from the source gNB. Thus, even when the source gNB is in outage state due to a sudden blockage or a rotation, the WTRU may still successfully complete a handover with the target gNB if a CHO execution condition is satisfied. The overall CHO procedure is illustrated in FIG. 6. The WTRU (102) may report (602) the cell quality measurement to its serving (source) cell (e.g., Source gNB 601). Different events called A1, A2, A3, A4, A5, etc. may be defined for WTRU measurement report triggering. Source gNB may make a CHO decision (604) to one or more target gNBs (603 and 605). Source gNB (601) may issue a handover request (606) to target gNB 603, and a request 608 to target gNB 605. If WTRU 102 is admitted (610, 612) by target gNBs (603, 605), target gNB (603) may send a handover request acknowledgement (614) to source gNB (601), which may contain an RRC message to be sent to the WTRU (102). Next, source gNB (601) may provide CHO configuration to the WTRU (102) through sending the RRC Reconfiguration message to the WTRU (102). After receiving the CHO configurations, the WTRU 102 may start evaluating CHO conditions (622). If the CHO conditions get fulfilled (624) for one of the configured target cells, such as target gNB (603), the WTRU 102 may detach from source cell (601) and synchronize (624) to target gNB (603). A successful synchronization may mark the CHO completion (628) from WTRU perspective. Target gNB (603) may send a handover request (630) to source gNB which responds by providing SN status (632). Source gNB may still be providing DL data (634) to target gNBs (603, 605) until path switch happens with the core network (638). Target gNB may send the message of WTRU context release to source gNB (640) after the path switch.

Although CHO is resilient to mobile blockers and significantly reduces the number of RLFs originating from one link deteriorating fast, the success of CHO may depend on the availability of candidate gNBs before the failure of the source link, the link quality of the target links, as well as the conditional thresholds for the target gNBs. Even if there are candidate gNBs, the WTRU may need to be able to maintain the link quality with the selected candidate gNB until the handover completion. Furthermore, a careful configuration of the conditional thresholds for the handover execution may also be needed. Higher threshold values may lead a WTRU failing to timely execute the handover to a target gNB resulting in a failed handover. On the other hand, lower threshold values may lead to a sub-optimal choice of a new serving gNB and potentially useless handovers in certain cases.

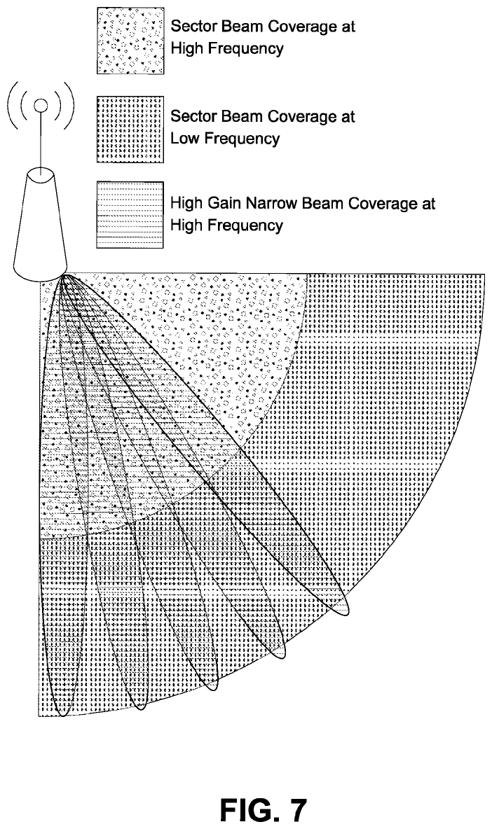

Regarding requirements at higher carrier frequencies, propagation at higher frequency bands may be more challenging than lower frequency bands. High propagation loss at higher frequencies may necessitate the use of high antenna-gain with narrow beam based directional (beamformed) transmissions. To increase the antenna-gain over a wide sector beam, larger antenna arrays (number of antenna elements ranging from tens to hundreds) may be used to form high gain beams. An example of effect on coverage and the compensation of path loss by using narrow beams at higher frequency is shown in FIG. 7. In such directional systems, since the spatial coverage for each Tx (transmit) beam is limited, multiple beams may be needed for transmitting DL common channels (e.g., system information, paging, etc.) to cover the entire cell area. The number of concurrent high gain beams that a gNB can support may be limited by the cost and complexity of the utilized transceiver architecture.

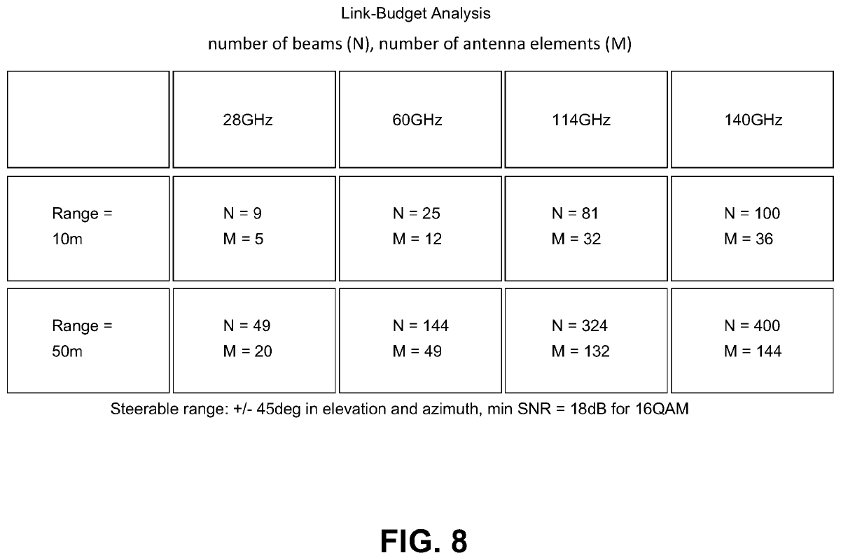

As the carrier frequency increases, the number of beams required to cover the entire cell may increase due to the higher beamforming gain required to overcome propagation loss limitations. As shown in FIG. 8, a link budget analysis may be performed to estimate the number of beams required to cover a sector of +/−45 degree for multiple coverage ranges at different millimeter wave carrier frequencies. As the carrier frequency increases, the number of required beams required to cover the sector may increase.

At higher frequencies, due to high attenuation and path loss, larger antenna arrays (number of antenna elements ranging from tens to hundreds) may be used to form high gain and narrower beams, e.g., directional transmissions, needed to increase the coverage distance. As frequencies increase, the beams may become narrower. The highly directional links result from narrower beams at both the WTRU and the gNB may be much more sensitive to dynamic changes in the environment compared to the conventional links. One dynamic change may result from the WTRU rotations which come from rotational movements of handset/wearable devices such as smartphone, game controllers, and VR/XR (virtual reality/extended reality) headsets, etc. These movements may originate from hand gestures, head movements etc. WTRU rotations may lead to channel variations between the serving gNB and the WTRU which causes beam misalignment or even the link/connection failures. Other types of dynamic changes may originate from translational mobility, rotational mobility or a combination thereof. Still another type of change can come when a serving link/beam may get blocked by a moving object other than the device itself without any type of device related mobility. This may require the target device being served through some sort of redundant links at the same position/location. Future applications with stringent QoS targets may require faster recovery from such failure situations no matter the cause, otherwise there is risk of not meeting the QoS targets and a compromised user experience.

The WTRU undergoing high mobility (TRANSLATIONAL or ROTATIONAL or mobility of a blocker or any combination of the previous mobility factors) may not always be able to detect, measure and report the beams which are becoming important, and could potentially be configured as the candidate serving Beams for BEAM_RECOVERY procedure. The result of such missing reporting may be that the gNB cannot configure the most suitable beam candidates for beam recovery procedure. Thus, the gNB configuration may not ensure BEAM_RECOVERY for the WTRU undergoing beam failure after such a high mobility happening.

Very high mobility, related to device itself (translational, rotational or a combination of the two) or related to the communication environment in the device proximity may also raise problems when the mobility requires a cell change. 3GPP has defined conventional (legacy) handover to enable cell change in mobility. A successful legacy handover may result in compromised link quality prior to establishing a fully functional link with the new serving cell—the phase of compromised link quality where the required QoS cannot be satisfied will be termed as “Outage” in this disclosure. When legacy handover is not successful, the WTRU may resort to RRC connection re-establishment procedure. RRC connection re-establishment procedure may result in much larger delays and potential loss of data when the WTRU may secure a connection through this procedure. In case of connection re-establishment failure, the WTRU may perform the cell selection from scratch as part of initial synchronization with worst outage. The high mobility originating from various factors as detailed above may lead to more failed handover scenarios resulting in RRC connection re-establishment and even the failures of re-establishment. The above mentioned processes may result in very large outages for the applications/services running on such devices.

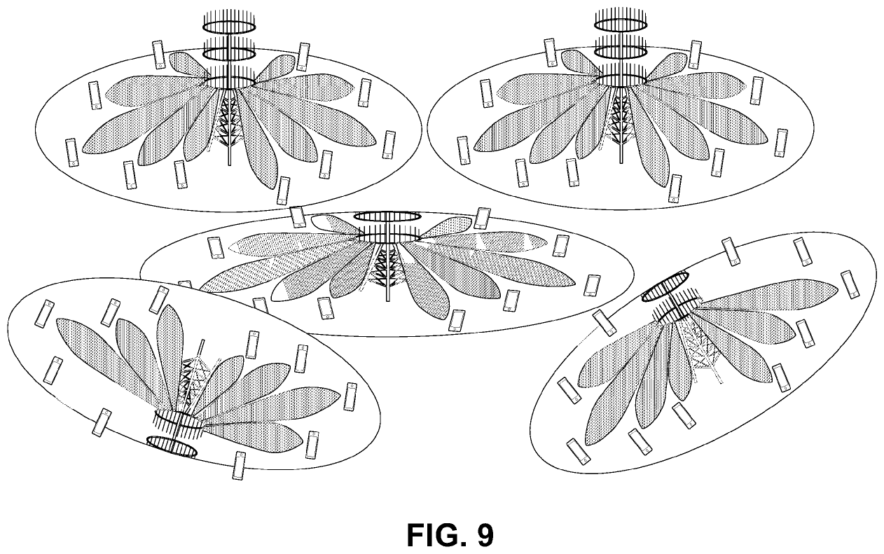

With the emergence of new concepts like ultra-massive MIMO (multiple input multiple output) and holographic MIMO, the TRPs (transmission and reception points) may radiate many (e.g., thousands) of beams—an example is shown in FIG. 9. The introduction of intelligent reflecting surfaces inside/outside the buildings, and meta-surfaces with fine granular control may add additional dimension to the number of beams and the granularity.

These surfaces may be fabricated with small meta elements. The surfaces may be controlled in terms of phase shifts to have extremely narrow beams focusing and tracking the target object. With the extremely narrow beams, even legacy mobility with moderate speeds may result in rapid change of beams to an extent making it difficult if not impossible to update the beams and cells with legacy beam recovery mechanisms or legacy handover mechanisms requiring active network involvement during each mobility event. The future devices may well exceed the mobility levels known which combined with the ultra-massive MIMO technology and resulting thousands of beams may make the legacy beam switching, beam recovery and mobility procedures completely inadequate meeting the requirements of future applications. In such scenarios with literally thousands of beams and high mobility, it will be impossible to have the WTRU feeding back each change of beam and requiring network direction to switch as the mobility rate in terms of beam change may result in extreme signaling overhead and latencies exceeding the requirements of future applications.

3GPP defined conditional handover (CHO) to combat the scenarios where the former serving cell has link quality degrading rapidly. A serving cell may provide the configuration of conditional handover and a set of conditional handover candidates to the WTRU. For each CHO candidate, conditions to execute the HO may be specified along with the configuration of the candidate cell. Typically, the WTRU may report the measurements of good quality non-serving cells to its serving cell that it can detect, and the serving cell may choose suitable candidate cells to be configured as CHO targets. Very high mobility may result in the WTRU's inability to detect, measure, and report the neighboring cells in a suitable manner. The inabilities may limit the network ability to configure the suitable candidate cells for CHO. A missing CHO configuration or non-execution of CHO may result in very high outage for services/applications running on the target WTRU device.

Even if the WTRU finds itself in-coverage of a specific BEAM/Cell post-mobility which might be one of the configured beam/cell among the set of configurations, The WTRU may need to establish the presence/coverage/strength of this beam/cell among the configured candidate cells/beams which may incur delays. Some of these beam/cell switching events may even require the beam/panel switch at the device as well further increasing the activation/refinement times prior to establishing a useful link. All of these delays may not be acceptable for future applications with stringent QoS targets.

Example embodiments may attempt to minimize the mobility related interruptions and outages while the WTRU is making transitions to different beams and cells under high mobility. Certain aspects related to very high frequency operation may aggravate the mobility situation. The antenna arrays/panels with large number of antennas required to facilitate directional links at higher frequencies generally may have limited angular coverage. For example, many of the antenna panels operating in sub-THz frequencies may be referenced for 15 to 30 degrees beamwidth. This limitation may come the way these antennas/panels are implemented at different devices, and the nature/style of these devices. Therefore, the WTRU with a limited number of antenna array panels may have limited angular coverage. As described herein, the term field of view (FoV) may be used to represent the angular coverage or angular range of an antenna panel for a given orientation. Rapid change in WTRU orientation due to rotations may incur sudden outages with the serving/source gNB, and the WTRU may not have discovered the neighboring beams available in the vicinity from the same TRP/gNB, from neighboring TRPs, or from neighboring gNBs. Another reason for non-detection may be insufficient time for the network to configure the measurements and gaps, and for the WTRU to make these measurements if configured. The missing configurations to recover from the beam failure events or to switch to neighboring cells through configured CHO candidates may result in loss of connections and may require larger delays despite beams/cells available in the vicinity from same gNB or from neighboring gNBs. The loss of connections may incur significant outages for the application running at the WTRU and may degrade the QoS metrics. To motivate the problem from another angle, one may consider some futuristic devices with special design where omni-directional coverage is not available. The unavailability of omni-directional coverage may also originate from low capability devices having limited antenna panels, limited transceivers and limited compute capability.

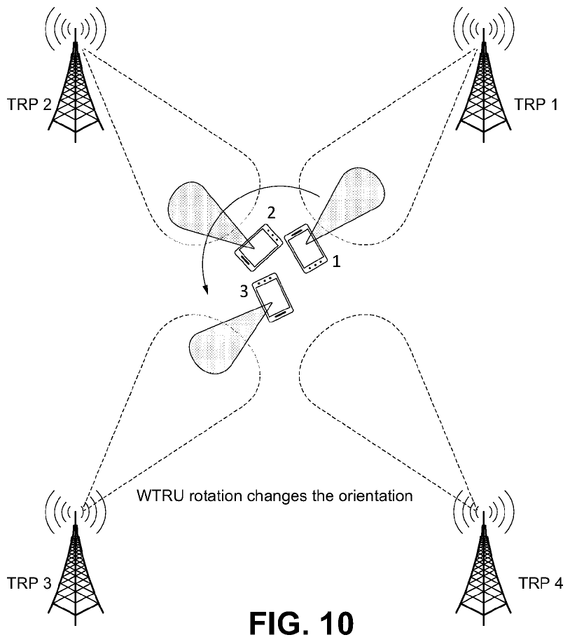

FIG. 10 may show an example situation where the WTRU is communicating initially with TRP 1. Initial position/orientation of the WTRU may be indicated by ‘1’. The next two orientations may be indicated as ‘2’ and ‘3’. The TRPs beams and WTRU beams may be indicated in the figure as blank and dashed beams respectively for each TRP and for each WTRU position/orientation. The WTRU in position 1 may not be able to discover the TRP 2 (TRP 3) whose coverage is in a non-overlapping angular space than the WTRU's beam. The non-detection may also be the result of network not having the time to configure the WTRU for measurements and proper measurements gaps configuration etc. At this time instant due to mobility, the WTRU position/orientation may become as in position ‘2’. The WTRU may lose the angular coverage space of TRP 1. In other words, the WTRU may undergo beam failure for its serving beam from TRP 1. In the current WTRU position/orientation ‘2’, the WTRU may be in coverage space of a suitable beam from TRP 2. As the WTRU had not discovered this beam, no measurements may have been reported. The network may not have configured the beam(s) from TRP 2 to the WTRU. Missing suitable configurations in terms of beam recovery and conditional handover may result in large delays before the WTRU will be able to establish suitable connection with the new TRP. The resulting outage may be unacceptable for the service/application running with higher QoS requirements and may lead to user dis-satisfaction.

Example embodiments as described herein may attempt to minimize mobility interruptions/outages where the devices can perform beam recovery and conditional hand-over in a seamless manner and the interruptions and outages during these transition events are minimized. An example embodiment, referred to as zero outage beam failure recovery, may target recovering from a beam failure event with minimal outage and interruption in a deterministic manner. As cellular networks are planned networks, the cellular network may have very precise knowledge of its deployment of cells, and the beams within those cells. What the network does not know may be how a specific WTRU will move from one cell/beam to another cell/beam. As a matter of fact, the information that how the specific WTRU will move from one cell/beam to another cell/beam may in general not be known to the WTRU itself. In general, the WTRU may have no information of network deployment in terms of cells and beams and the geographic areas where these cells/beams are active. A proposed approach may target using the known deployment of cells/beams from the networks by network providing a finite snapshot of network deployment to the WTRU along with suitable coordinates binding the cells/beams to geographic locations and orientations. The WTRU may use the information from local sensors and interfaces to extract its current geographic parameters. The WTRU may use its current geographic parameters to determine the suitable candidate beam from the network provided configuration. This process may ensure a zero outage beam recovery in case of beam failure.

In an example embodiment, a WTRU may provide the assistance information (details in the following paragraphs) to the gNB. The gNB may use this information to prepare zero outage beam recovery configuration. The gNB may provide zero outage beam recovery configuration to the WTRU. In the event of a compromised quality of a serving beam, the WTRU may determine the suitable candidate beam as a function of data available through its local sensors and potentially combined with other radio measurements, validates, and performs beam recovery with the selected candidate. The assistance information may be a key element in the proposed approach which in the first place is transmitted to the gNB and used to prepare a suitable configuration for the target WTRU. A novel element of the configuration beams may be their association or mapping to WTRU geographic coordinates or the data from sensors plus other radio measurements. The network may provide this configuration to the WTRU. After a beam failure, the WTRU may use the information from local sensors potentially combined with radio measurements to determine the most suitable candidate beam according to the configured mapping from the network. In the following, the assistance information may be defined broadly. The key steps of the proposed zero outage beam recovery procedure may be described.

The assistance information from the WTRU may be broadly categorized in two groups, termed as measurement-based data and non-measurement-based data. The first group may comprise of all the information that can be estimated, measured, determined with or without post-processing over the signals received from the radio interface where mobility is being considered. The first group may be termed as measurement-based (e.g., radio measurement-based) data. The first group may comprise of receiving, measuring, and processing the reference signals on the physical layer, MAC information elements, RRC messages received from the network, or the information received at higher layers. The measurements may be in the form of RSRP (reference signal received power), RSSI (received signal strength indicator), RSRQ (received signal received quality), SNR (signal to noise ratio), or SINR (signal to interference and noise ratio).

The second group may comprise of all the information that is not extracted from the network signaling. The second group may be termed as non-measurement-based data. The first sub-group in non-measurement-based data may comprise of the WTRU capability and implementation details covering its antenna panels, respective field-of-views for those panels, transceivers and power characteristics, switching delays, and simultaneous operation for the panels etc. The second sub-group in non-measurement-based data may encompass all the information extracted or measured through local sensors and interfaces other than the radio interface where mobility is being considered. The example of local sensors may include positioning sensors, gyroscopes, accelerometers, etc. The interfaces other than the considered radio interface may be wired interfaces like ethernet, wireless interfaces like Bluetooth, WiFi or any other proprietary wired or wireless interfaces. Yet the third sub-group in non-measurement-based data may comprise of the mobility metrics and configurational triggers. The examples of mobility metrics may be the speed (translational or/and rotational), direction (translational or/and rotational), velocity, trajectory, or/and history of mobility to name a few. The relevant configurational may trigger helpful for mobility management and providing the suitable configuration could come from situational or contextual information—e.g., a vehicular device (or the devices inside) starting its trajectory to a destination where both the start and the trajectory could be very important from the configuration perspective. Another example may include the start of a network game from an AR/VR device potentially including user profile which may incorporate or provide the user behavior in terms of rotations during the game. Such parameters may also be updated by the WTRU while having received some BFR configuration from the gNB. The gNB may also update the BFR configuration upon receiving the updated assistance information from the WTRU or other factors.

In some cases, overlapping may occur. For example, similar information may be available in measurement-based and non-measurement-based group. One example may be the positioning, where the network provides some positioning information (measurement-based) while the WTRU is equipped with a local positioning sensor which extracts the positioning information from any of the satellite systems. In such a case, one information set or the other information set may be used, or both information sets may be combined to achieve better accuracy, granularity, or information quality.

After having defined the assistance information, example steps of the proposed approach may be summarized here and detailed further below. The WTRU may provide assistance information to the gNB. This assistance information may incorporate and streamline the potential information which the WTRU measures and obtains through the signals received from the network, or the WTRU can obtain through other interfaces or extract from its local sensors. It may be possible for a WTRU to update its assistance information, at least for certain parameters under certain conditions.

The gNB may provide the zero-outage beam recovery configuration in response to the WTRU assistance information. This configuration may be based upon the network deployment of cells, TRPs, beams and WTRU provided assistance information. The configuration preparation may take into account any historical data about WTRU parameters, applications usage, WTRU subscription status etc. The configuration preparation may use the artificial intelligence and machine learning algorithms to prepare the configuration suitable to the WTRU in a predictive manner using all the network and WTRU data.

The zero-outage beam recovery configuration may comprise a set of candidate beams for recovery and the mapping of these candidate beams to suitable parameters which encompass measurement-based and non-measurement-based data. As an example, the candidate beams may be mapped to active zones (in terms of position/location, angular span, WTRU Panel) where these beams are activated with zero outage. Another example where measurement-based selection criteria with associated parameters (e.g., thresholds) may be configured for one or more candidate beams.

After a mobility event (resulting from device mobility or mobility in the environment) leading to compromised beam quality or beam failure, the WTRU may use the relevant information from radio measurement and non-measurement-based data such as from the WTRU's local sensors. The WTRU may identify the suitable beam/cell from the network configured mapping and perform the procedure of beam failure recovery with this derived candidate beam.

In legacy BFR procedure, the WTRU may be sending a list of candidate beams in a normal or truncated BFR MAC-CE. For ultra-massive MIMO beam scenarios with high mobility, making measurements over multiple candidates may result in increased interruption and outage time while the WTRU is transitioning to the new candidate. This may become severe for the cases when the WTRU needs to use different antenna panels or use measurement gaps to make such measurements. For this purpose, zero outage procedure may circumvent the procedure of making measurements on multiple candidate beams and reporting them to the network.

WTRU assistance information may comprise of two groups: one termed as measurement-based data and the other termed non-measurement-based data. The assistance information may be grouped in different manners. One design compatible to the proposed approach may categorize the assistance information in radio-measurement-quantity-based-data and non-radio-measurement-quantity-based-data. The first group of radio-measurement-quantity-based-data may comprise of all radio measurements that can be configured by the radio network. The first group of radio-measurement-quantity-based-data may comprise of all the measurements on NR, E-UTRAN, UTRAN and WiFi etc. The measurements pertaining to different RATs (radio access technologies) may include the existing measurement quantities or the support for new measurement quantities can be introduced. The second group of non-radio-measurement-quantity-based-data may group all the remaining assistance information that may be useful to minimize interruptions during the beam failure recovery process. The information elements in the second group may include the parameters and quantities that the WTRU is capable of providing based upon other local interfaces and local sensors etc. A sub-group in the second group of non-radio-measurement-quantity-based-data may include a set of parameters and quantities related to WTRU capability and specific implementation details (including but not limited to antennas, panels, detailed implementation on antenna panels—e.g., field of view, power characteristics, radiation patterns, architecture details as how the transceivers link to different panels, beam steering capabilities including digital, analog/phase-shifts and hybrid based, transition time for beam steering and panel switching delays, etc.). The mobility relevant may trigger helpful for mobility management coming from situational or contextual information—e.g., a vehicular device (or the devices inside) starting its trajectory to a destination, or the trigger about the start of a network game from an AR/VR device potentially including user profile could also be part of the non-radio-measurement-quantity-based-data.

In a different, yet compatible, grouping of assistance information, three groups may be defined as radio-measurement-quantity-based-data, non-radio-measurement-quantity-based-data and WTRU-capability-and-implementation-based data. In this categorization, radio-measurement-quantity-based-data may be the same as defined previously. Non-radio-measurement-quantity-based-data may comprise all the measurements which are not part of the first group and could be made through local interfaces and local sensors, plus the mobility triggers providing situational and contextual information. The third group may include a set of parameters and quantities related to WTRU capability and specific implementation details.

Zero outage beam recovery may be performed. The WTRU may have limited discovery of neighboring beams around it for various reasons and at any moment the WTRU may find itself in a situation where it had not discovered a-priori the detectable beams in the vicinity. This situation may result if the WTRU makes a fast translational movement, or it undergoes a large rotation, or a combination of the former two. This may also be due to limited numbers of antennas, antenna panels, transceivers or stringent requirements on power consumption. These situations and/or aspects may result in limited neighboring beams being discovered and reported by the WTRU to the network. With the legacy beam management and beam recovery procedures which typically base the configurations upon reporting of detected beams, the configurations from the network may not be sufficient. A missing beam recovery configuration for the beams that a WTRU finds detectable in the vicinity may result in the inability of beam failure procedure to let a WTRU recover to these beams. This may ultimately result in radio link failure as both beam management and radio link monitoring are running in parallel at a WTRU. Radio link failure may then result in WTRU doing the cell search, and RRC configuration procedures from scratch which are highly time consuming and detrimental for ongoing traffic flows.

In the proposed approach, the WTRU may provide assistance information to the gNB. This information may comprise of the measurement-based data and non-measurement-based data as detailed earlier. Based upon the received assistance information, the base station may provide the WTRU a set of candidate beams around the WTRU's geographic coordinates along with a mapping which associates the candidate beams to the new geographic coordinates. The updated geographic coordinates may be any subset of parameters from the assistance information. These parameters may be taken to be outside of assistance information but for which the gNB knows that WTRU will be able to have them known through its local sensors or other interfaces. In one simple example, the mapping of candidate beams may be provided with respect to their orientation indication. This orientation indication may be in the form of angular coverage with respect to a suitable reference beam. The angular coverage may be defined using azimuthal angles, elevation angles or a combination of the two. The reference beam indication may be part of the configuration. The reference beam may be defined as an SSB beam or a CSI-RS beam. In addition, the reference beam may be the actual beam through which the network is serving a WTRU. Instead of reference beam, reference direction may be specified using other approaches, e.g., geographical north or some other reference which is understandable to both the network and the WTRU. In one example, the orientation information may be given with respect to one or more configured TCI states where a TCI state contains QCL reference information with a DL or UL beam/RS. In another example, the candidate beams may be provided mapping against the position and the orientation, both noted in suitable coordinates and in appropriate quantized forms.

For each beam in the configured set, in addition to its angular span around a WTRU, the gNB may provide the relevant parameters to initiate contention free RACH access within that beam. This may include the RACH parameters, for example, RACH preamble sequence identity, RACH duration, power ramping parameters, the parameters related to RACH occasions associated to the indicated beam, etc. The configuration may provide RACH parameters for 4-step RACH, 2-step RACH or both. In addition, prioritized RACH access parameters may be specified as part of the configuration to speed up beam failure recovery.

Another optimization may be to design special search spaces for beam failure recovery. In one design, these search spaces may have higher periodicity for fast network feedback. They may also be made simpler to reduce WTRU decoding complexity for BFR message exchanges.

For the beams configured as part of zero outage BFR, special procedures may be designed which may provide the RACH behavior, for example, providing the network knowledge of WTRU recovering through a specific beam. These procedures may be variations of RACH, for example making RACH faster, more reliable, and faster, or new design through signaling mechanisms.

Another method may be to provide the configuration of UL and DL bandwidth parts which are activated and used for beam failure recovery procedures. These may be different from active BWP pre-BFD event.

The configuration may also include the conditions under which the configuration stays valid. The configuration may have a timer and the validity may expire upon the expiry of this timer. Another configuration release condition may be associated with the mobility, for example, if the configured device moves away from its last known position/location by more than a configured threshold, it will release the zero-outage configuration. For this purpose, suitable zones may be created by configuration. The WTRU may keep track of its zone. The exit condition may specify when to release the configuration. One example may include if the WTRU just moves out of its current zone. In another example, the configuration may be valid in the current zone and direct neighbors having overlapping boundaries. In this case, if the WTRU moves out of direct neighbor zones, it may release the zero-outage configuration. Another example where the configuration release condition may associate with the device's timing advance value (e.g., with the serving gNB), e.g., if the device moves and the change in the timing advance is above a configured threshold, the device may be configured to release the current active zero-outage configuration. More broadly, any suitable combination of parameters from the assistance information may be used to define the validity conditions and the release conditions.

In another solution, one or more zero-outage configurations may be given to the device. The mapping/association of a configuration with a zone, a location, or a timing advance value/range may be given to the device. The device may select the configuration based on the tracking of the associated metric (zone, location, or timing advance, etc.).

For systems based upon ultra-massive MIMO having the capability of deploying thousands of beams per TRP, to contain the overhead the network deployment of beams may follow certain rules and may be provided in a compact form. In one example, the beam deployment may follow a pattern in azimuthal and elevation dimensions. A set of patterns may be known in tabular forms or through formulae. The network may choose a suitable pattern for its deployment according to its requirements in a given geographic area. For such cells and beam deployments, the network may provide the compact form of deployment pattern to the WTRU as part of the zero outage beam recovery configuration. The configuration may include the positions of TRPs in suitable coordinates. The WTRU receiving such configuration may determine the nearest TRPs for any location and then determine the beam map using the pattern indication. The parameters for each constituent beam, its identity, associated reference symbols parameters, RACH occasions, RACH preambles and other parameters may also be conveyed to the WTRU as part of the configuration in suitable compact form.

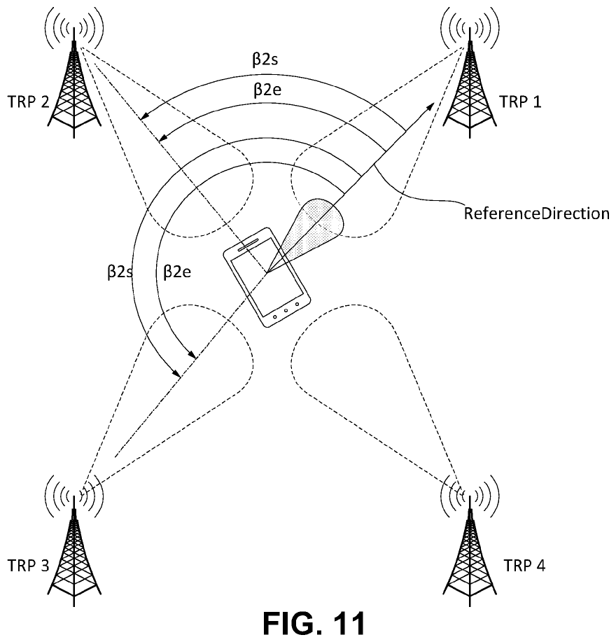

An example configuration is shown in FIG. 11 for the WTRU communicating with TRP 1. This figure shows the configuration comprising an indication of reference direction with the current beam, and the neighboring beams with their angular spans. In this example figure, a beam from TRP 2 may be configured with its span marked with respect to the reference (beam) direction as a start angle (β2s) and an end angle (β2e). Similarly, the figure may show the start and end angles for an exemplary beam from TRP 3 as β3s and β3e. For each configured beam, the gNB may provide the RACH related details to allow CFRA within that beam. The same configuration information may be provided by providing one angle from the reference direction/beam to the center of a candidate beam, and in addition providing the beam width for each beam. This may be further simplified if the beam width is same for each beam, and then one single beam width is provided for each candidate beam.

When there is comprised quality of the beam to which the WTRU is attached, the PHY layer may report beam failure indication (BFI) to the MAC layer. The PHY layer may generate BFI indications when the reference symbols associated to a beam fall below a configured threshold. These conditions may be defined on SSB, CSI-RS, or a combination of both. For ultra-massive MIMO, there may potentially be new reference symbol structures. One implementation may be in the form of layered architecture where narrow beams are overlaid over wider beams. There may be multiple layers of such varying width beams. The beam failure conditions may be suitably defined and configured using the existing reference symbols or the new reference symbols defined for emerging networks having large number of beams and suitable thresholds to be evaluated in view of those reference symbols.

If the WTRU undergoes beam failure, for example as a result of a fast rotation, the WTRU may get the locally available information of amount of rotation from local sensors and/or gyroscope. It computes its fresh orientation using the rotation information and the network indicated reference beam/direction. The network configuration may have indicated a variety of beams with their angular coverages. The WTRU may determine the suitable beam with respect to its locally determined orientation after the rotation event. This may let the WTRU know precisely which beam it should have line-of-sight connection with respect to its new orientation. As a result, the WTRU may not need to perform blind decoding and cell searches to find SSB beams and later perform the lengthy beam refinement procedures to reach a suitable active connection.

After having established the suitable beam from the gNB provided configuration, the WTRU may use the configured parameters to be used for beam recovery with respect to its newly determined beam. It may send contention free RACH with the configured RACH parameters over the configured RACH resources linked to the determined suitable beam.

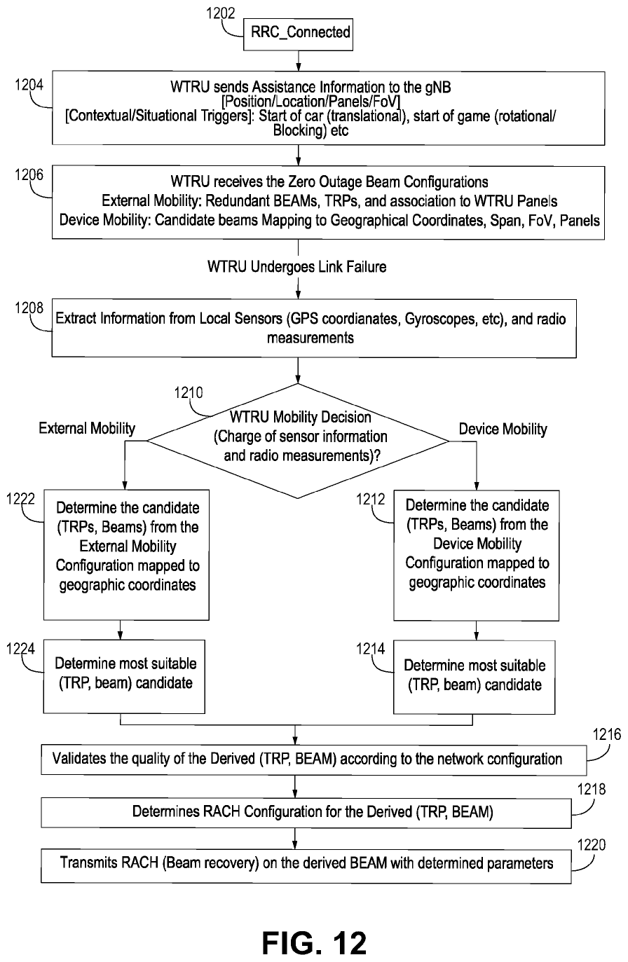

FIG. 12 shows an example flow chart for a zero-outage beam recovery procedure. For a WTRU in RRC_CONNECTED state (1202), the WTRU may send the advanced Assistance Information to the network/gNB (1204). This information from the WTRU may include the measurement-based information and non-measurement-based information. The parameters and elements for both broad categories within assistance information may have been detailed earlier. In addition, the assistance information may carry the information from WTRU situation/context and the applications running which may require uncompromised mobility. This may include some triggers which may indicate that potentially device may undergo mobility situations leading to outages. The examples of such triggers may be a car starting to move (which may result in high translational mobility), head-mounted display (HMD) device or other AR/VR gadgets indicating the start of a virtual/mixed reality game (where rotational mobility and mobile blockers may lead to outages) etc.

Based upon the assistance information, the gNB may provide suitable configuration to the WTRU for beam recovery (1206). This configuration may comprise the candidate beams and suitable mapping of these candidate beams to geographic coordinates (including but not limited to locations/zones/spans etc.). The network configuration also may comprise the parameters and thresholds for the WTRU to apply to its updated geographic coordinates (e.g., zone/location/position and span) using local sensors and interfaces (1208), so as to pick the suitable beam from the suitable TRP using the configured mapping table. The configuration may include two sets of configurations, one to handle the device mobility where the device may be undergoing translational and rotational movements, and the other configuration focusing on the external mobility where the interruptions may be originated from the environment and not the result of direct device mobility. As an example, the external mobility resulting from mobile blockers may provide the beams/TRPs which are able to provide the coverage to the target device with its known location/position at the gNB when the serving beam may undergo failure. This may require the WTRU/device switching and activating to a different panel which gNB may provide the indication as part of configuration. This indication may be in turn based upon the WTRU providing the implementation and capabilities of its antenna panels, transceivers, switching delays and detailed feature set as part of its assistance information.

In a compatible design, the configuration may comprise two sub-configurations where one sub-configuration is geared to translational mobility and the other sub-configuration is geared towards rotational mobility and external mobility (including the blockage events in the network). This may be useful in the sense that a rotation of the device itself, or the blocking of a beam due to mobility in the network may require the device to choose a beam having the coverage to the same position but with a different orientation.

In a compatible approach, the network may provide a set of beam recovery configurations to a WTRU. The network may provide the association of these configurations to different applications, different QoS for example different reliability requirements, different power consumption targets at WTRU, WTRU active service subscription level etc. When a beam failure event occurs, the WTRU may choose the suitable beam recovery configuration according to the current situation as per the configured criterion. As described earlier, the multiple configurations may be associated to different physical parameters (like external or device mobility), different service reliability targets (one configuration while higher reliability is required and once configuration for lower reliability), different subscription levels (one configuration when the WTRU is using paid content vs one configuration for the non-paid- content) etc.

For the WTRU in RRC_Connected state (1202), the WTRU may send the assistance information to the gNB (1204). The WTRU may receive the zero outage beam configurations (1206), with one set of configurations for external mobility and one set of configurations for device mobility. In the event of mobility resulting in a compromised quality of the serving beam(s) according to the configured beam quality threshold, a WTRU may extract the information from its local sensors (1208). The sensors information may be combined with radio measurements over existing or newly designed reference signals received from the network. One example may be to combine the local sensors data with measurements performed using downlink positioning reference signals. The WTRU may use this information to select the correct set of candidate beams from the device mobility or external mobility configuration (1210). The WTRU may map the information from local sensors to the suitable format of location/zone/orientation as per the configuration and then derives its location/orientation. With this location/orientation, the WTRU may determine the suitable beam (from the suitable TRP) from the configured mapping (1222 for external mobility and 1212 for device mobility).

The entries in the mapping table may provide multiple candidate beams for a given location/orientation. In this case, the gNB may provide priority order for the candidate beams, and priority order for the TRPs as well. For example, prioritization (e.g., biasing) over beams or/and TRPs may be performed by the network to optimize its load balancing, energy savings, or/and deployment scenarios, etc. The WTRU may determine the most suitable candidate (1224 for external mobility or 1214 for device mobility). The WTRU may validate the quality of the determined candidate 1216 and determine the associated RACH configurations 1218. The WTRU may then perform the beam recovery procedure 1220 on this determined beam using the configured set of recovery parameters. The beam recovery may be typically transmitting contention free RACH with configured parameters, e.g., indicating RACH sequence number, RACH occasion, timing and power ramping.

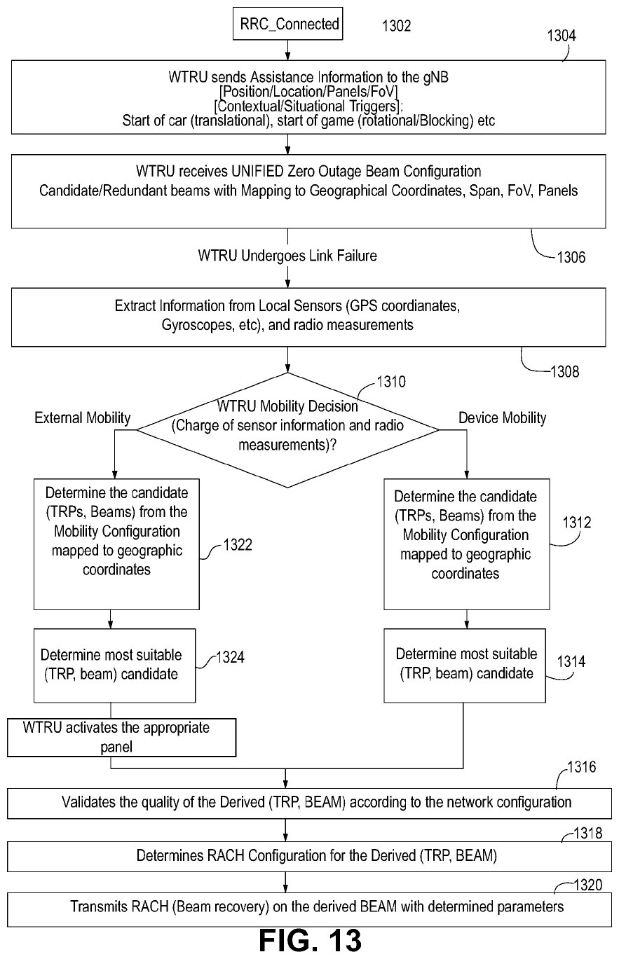

In a compatible design to enable zero outage beam failure recovery, the configuration for candidate beams may be provided as a unified configuration. In this unified configuration, all the candidate beams and their priorities may be provided with their mapping to suitable geographic coordinates, orientations, and association with other parameters the WTRU can extract and use to determine the suitable beam. This unified configuration may harmonize the design which provides the candidates that the WTRU can use in case of beam failure, independent of the reason (e.g., external mobility or device mobility) causing the beam failure. FIG. 13 shows an example flowchart for zero outage beam failure recovery with unified global configuration. For the WTRU in RRC_Connected state (1302), the WTRU may send the assistance information to the gNB (1304). The WTRU may receive the zero outage beam configurations (1306). A change here compared to the previous figure may be that the network configuration for beam/TRP candidates is provided in a unified manner, encompassing the candidates targeting external mobility and device mobility.

Once the device is undergoing beam failure, the WTRU may get the information from its local sensors (1308) to decide whether the link failure is happening due to device mobility or external mobility (1310). This information combined with the information extracted from other interfaces and other sensor, the WTRU may pick the most suitable configuration for beam failure recovery for example based on its geographic coordinates (1322 for external mobility and 1312 for device mobility). The most suitable configuration may be directly derived from the network configured priority of each candidate beam for the WTRU's geographic coordinate. The WTRU may pick this configuration. The WTRU may need to activate a different antenna panel as per the selected configuration. The flowchart may show the suitable panel activation only for External Mobility case where certainly it is more relevant, though the activation of suitable panel may also be needed for Device Mobility case. In one example, the network may also configure a priority order for the WTRU's antenna panels based on the WTRU assisting information on supported antenna panels sent to the network. The WTRU may select an antenna panel as per the configured priority order. With a suitable antenna panel activated (e.g., with highest priority), the WTRU may validate the selected TRP/beam combination according to the configured parameter settings (1316). The quality validation may be configured in terms of RSRP, RSRQ or SINR using suitable indicated measurement object from the selected TRP/beam. If the selected configuration satisfies the quality criterion, the WTRU may select the RACH configuration (1318) associated to the selected TRP/beam and transmit RACH (1320) on the derived resource. Although not shown in the flowchart for keeping the design clear to follow, if the selected TRP/beam does not satisfy the configured quality criterion, the WTRU may choose the next higher priority beam from the provided configuration until it finds the highest priority beam satisfying the quality criterion. In case of prioritization over the panels, if the WTRU does not find any suitable beams satisfying the quality criterion using the first selected panel, the WTRU may select the next higher priority panel from the provided configuration and find a suitable beam as per the given priority order for the beams. To speed up the process, the WTRU may take the multiple candidates indicated for the current geographic coordinates and decide the highest priority candidate satisfying the quality criterion to trigger the recovery process on this candidate. If no configured candidate satisfies the quality criterion, the WTRU may resort to legacy beam recovery procedure.

In the following, two example designs are discussed for zero outage beam recovery configuration. A first design may propose a standalone design for zero outage BFR. The second design may propose a joint design for legacy and zero outage BFR. To make the exposition simple, a limited set of mapping parameters for candidate beams (rotational/orientation aspects) are shown in these designs. It should be appreciated that additional parameters for the candidate beams in terms of geographic coordinates, orientation, other subset of assistance information, and priorities may be indicated in the same manner.

In this section, a design may be discussed in which zero outage BFR information element (IE) is defined as an individual configuration element. Zero Outage Beam Failure Recovery Configuration IE may be introduced as part of configuration with new structures which associate each SSB/CSI-RS resource to a reference position/location and angular span.

In addition, each candidate beam whether based upon SSB or CSI-RS may be indicated with respect to a suitable reference against which its span is indicated. We may introduce new structures/templates where for each candidate beam, we provide the reference position/location for the WTRU and its angular span. An example for zero outage beam failure recovery configuration structure may be provided in the following. This information element may use the legacy parameters such as rootSequenceIndex-BFR, rach-ConfigBFR, and/or rsrp-ThreshoholdSSB etc. ZeroOutage-BFR-SSB-Resource and ZeroOutage-BFR-CSI-RS-Resource may be the key parameters which associate the candidate SSB/CSI-RS beams to their respective active coverage areas through the parameter ZeroOutage-BFR-Map. ZeroOutage-BFR-Map may provide the beam coverage in terms of beam-reference-orientation, beam-start-angle and beam-end-angle parameters. This may be by way of example and other parameters that are used to define the area associated to a candidate beam. Below is example pseudo code for a zero outage beam failure recovery configuration.

| | |
|---|---|
| ZeroOutageBeamFailureRecoveryConfig ::= | SEQUENCE { |

| | |
|---|---|
| rootSequenceIndex-BFR | INTEGER (0..137) |

OPTIONAL, -- Need M

| | |
|---|---|
| rach-ConfigBFR | RACH-ConfigGeneric |

OPTIONAL, -- Need M

| | |
|---|---|
| rsrp-ThresholdSSB | RSRP-Range |

OPTIONAL, -- Need M

| | |
|---|---|
| ZeroOutagecandidateBeamRSList | SEQUENCE |

(SIZE(1..maxNrofZeroOutageCandidateBeams)) OF ZeroOutagePRACH-

| | |
|---|---|
| ResourceDedicatedBFR | OPTIONAL, -- Need M |

| | |
|---|---|
| ssb-perRACH-Occasion | ENUMERATED {oneEighth, oneFourth, oneHalf, one, |

two,

| | |
|---|---|
| four, eight, sixteen} | OPTIONAL, -- |

Need M

| | |
|---|---|
| ra-ssb-OccasionMaskIndex | INTEGER (0..15) |

OPTIONAL, -- Need M

| | |
|---|---|
| recoverySearchSpaceId | SearchSpaceId |

OPTIONAL, -- Need R

| | |
|---|---|
| ra-Prioritization | RA-Prioritization |

OPTIONAL, -- Need R

| | |
|---|---|
| beamFailureRecoveryTimer | ENUMERATED {ms10, ms20, ms40, ms60, ms80, |

| | |
|---|---|
| ms100, ms150, ms200} | OPTIONAL, -- Need M |

```
  ...,
  [[
```

| | |
|---|---|
| msg1-SubcarrierSpacing | SubcarrierSpacing |

```
OPTIONAL -- Need M
  ]],
  [[
```

| | |
|---|---|
| ra-PrioritizationTwoStep-r16 | RA-Prioritization |

OPTIONAL, -- Need R

| | |
|---|---|
| candidateBeamRSListExt-v1610 | SetupRelease{ CandidateBeamRSListExt-r16 } |

```
OPTIONAL -- Need M
  ]],
  [[
```

| | |
|---|---|
| spCell-BFR-CBRA-r16 | ENUMERATED {true} |

OPTIONAL -- Need R
]]
}

| | |
|---|---|
| ZeroOutagePRACH-ResourceDedicatedBFR ::= | CHOICE { |

| | |
|---|---|
| ssb | ZeroOutage-BFR-SSB-Resource, |
| csi-RS | ZeroOutage-BFR-CSIRS-Resource |

}

| | |
|---|---|
| ZeroOutage-BFR-SSB-Resource ::= | SEQUENCE { |

| | |
|---|---|
| ssb | SSB-Index, |

| | |
|---|---|
| active-area | ZeroOutage-BFR-Mapping, |

| | |
|---|---|
| priority | INTEGER (range from Lowest Priority to Highest Priority) |

| | |
|---|---|
| ra-PreambleIndex | INTEGER (0..63), |

...
}

| | |
|---|---|
| ZeroOutage-BFR-CSIRS-Resource ::= | SEQUENCE { |

| | |
|---|---|
| csi-RS | NZP-CSI-RS-ResourceId, |

| | |
|---|---|
| active-area | ZeroOutage-BFR-Mapping, |

| | |
|---|---|
| priority | INTEGER (range from Lowest Priority to Highest Priority) |

| | |
|---|---|
| ra-OccasionList | SEQUENCE (SIZE(1..maxRA-OccasionsPerCSIRS)) OF |

| | | |
|---|---|---|
| INTEGER (0..maxRA-Occasions-1) | OPTIONAL, | -- Need R |

| | |
|---|---|
| ra-PreambleIndex | INTEGER (0..63) |

OPTIONAL, -- Need R
...
}

| | |
|---|---|
| ZeroOutage-BFR-Mapping ::= | SEQUENCE { |
| beam-reference-orientation | Reference-Orientation [in suitable coordinates] |
| beam-start-angle | BEAM-Start-Angle |

| | |
|---|---|
| beam-end-angle | BEAM-End-Angle |

...
}

In this embodiment, each candidate beam may have its indication of active area which is a structure of type ZeroOutage-BFR-Mapping. This may be defined with suitable parameter sets from measurement based information elements or non-measurement based information elements.

A compatible design for providing the beam mapping may be the one where each beam is defined to have a reference angle. An example may be the center of the beam. Then for each candidate beam, its orientation may be specified with respect to the reference beam/angle, and its beam width is provided. In the following zero outage beam failure recovery map example, ZeroOutage-BFR-Map may provide the beam coverage in terms of beam-reference-orientation, beam-orientation and beam-width parameters. This may be by way of example and other parameters that are used to define the area associated to a candidate beam. Below is example pseudo code for zero outage beam failure recover (BFR) mapping.

| | |
|---|---|
| ZeroOutage-BFR-Mapping ::= | SEQUENCE { |

beam-reference-orientation Reference-Orientation [in suitable coordinates]

| | |
|---|---|
| beam-orientation | Orientation-wrt-Reference-Orientation [in suitable coordinates] |
| beam-width | BEAM-WIDTH [in suitable coordinates] |

...
}

The configuration may be further updated if all SSB beams are to have a common beam width and all CSI-RS beams are to have a common beam width. The beam angles no matter defined as start and end angles with respect to a reference or a reference beam orientation angle defined with respect to a reference may be defined as the azimuth angle and vertical angle with respect to a reference direction. The reference direction may be defined in the global coordinate system (GCS) or the local coordinate system (LCS). In GCS, estimated azimuth angle may be measured relative to geographical North and is positive in a counter-clockwise direction and estimated vertical angle is measured relative to zenith and positive to horizontal direction. In LCS, estimated azimuth angle is measured relative to x-axis of LCS and positive in a counter-clockwise direction and estimated vertical angle is measured relative to z-axis of LCS and positive to x-y plane direction.

Although the zero outage BFR procedure may operate in a standalone configuration, it may still run in parallel with legacy BFR procedure. A WTRU may thus receive configuration of a set of candidate beams with suitable mapping for zero outage BFR, and at the same time may receive a set of candidate beams for legacy BFR procedure.

In this section, a unified configuration setup may be discussed which includes zero outage BFR and legacy BFR. When a network decides to configure a WTRU with BFR candidates, the configuration design may be unique which can be used to provide a set of candidate beams for the legacy BFR and a set of candidate beams for the proposed zero outage BFR. The two sets may have overlapping candidate beams. The IE BeamFailureRecoveryConfig may be used to configure the WTRU with RACH resources and candidate beams for beam failure recovery in case of beam failure detection. An example for zero outage beam failure recovery configuration structure may be provided in the following. This information element may use the legacy parameters such as rootSequenceIndex-BFR, rach-ConfigBFR, rsrp-ThreshoholdSSB etc. ZeroOutage-BFR-SSB-Resource and ZeroOutage-BFR-CSI-RS-Resource may be the key parameters which associate the candidate SSB/CSI-RS beams to their respective active coverage areas through the parameter ZeroOutage-BFR-Map. ZeroOutage-BFR-SSB-Resource and ZeroOutage-BFR-CSI-RS-Resource may be used in addition to legacy BFR-SSB-Resource and BFR-CSI-RS-Resource and provide the relevant area for each SSB/CSI-RS beam. Below is example pseudo code for a beam failure recovery configuration information element.

-- ASN1START
-- TAG-BEAMFAILURERECOVERYCONFIG-START

| | |
|---|---|
| BeamFailureRecoveryConfig ::= | SEQUENCE { |

| | |
|---|---|
| rootSequenceIndex-BFR | INTEGER (0..137) |

OPTIONAL, -- Need M

| | |
|---|---|
| rach-ConfigBFR | RACH-ConfigGeneric |

OPTIONAL, -- Need M

| | |
|---|---|
| rsrp-ThresholdSSB | RSRP-Range |

OPTIONAL, -- Need M

| | |
|---|---|
| candidateBeamRSList | SEQUENCE (SIZE(1..maxNrofCandidateBeams)) OF |

| | |
|---|---|
| PRACH-ResourceDedicatedBFR | OPTIONAL, -- Need M |

| | |
|---|---|
| ZeroOutagecandidateBeamRSList | SEQUENCE |

(SIZE(1..maxNrofZeroOutageCandidateBeams)) OF ZeroOutagePRACH-
ResourceDedicatedBFR OPTIONAL, -- Need M

| | |
|---|---|
| ssb-perRACH-Occasion | ENUMERATED {oneEighth, oneFourth, oneHalf, one, |

two,

| | |
|---|---|
| four, eight, sixteen} | OPTIONAL, -- |

Need M

| | |
|---|---|
| ra-ssb-OccasionMaskIndex | INTEGER (0..15) |

OPTIONAL, -- Need M

| | |
|---|---|
| recoverySearchSpaceId | SearchSpaceId |

OPTIONAL, -- Need R

| | |
|---|---|
| ra-Prioritization | RA-Prioritization |

OPTIONAL, -- Need R

| | |
|---|---|
| beamFailureRecoveryTimer | ENUMERATED {ms10, ms20, ms40, ms60, ms80, |

| | |
|---|---|
| ms100, ms150, ms200} | OPTIONAL, -- Need M |

```
  ...,
  [[
```

| | |
|---|---|
| msg1-SubcarrierSpacing | SubcarrierSpacing |

```
OPTIONAL -- Need M
  ]],
  [[
```

| | |
|---|---|
| ra-PrioritizationTwoStep-r16 | RA-Prioritization |

OPTIONAL, -- Need R

| | |
|---|---|
| candidateBeamRSListExt-v1610 | SetupRelease{ CandidateBeamRSListExt-r16 } |

```
OPTIONAL -- Need M
  ]],
  [[
```

| | |
|---|---|
| spCell-BFR-CBRA-r16 | ENUMERATED {true} |

OPTIONAL -- Need R
]]
}

| | |
|---|---|
| PRACH-ResourceDedicatedBFR ::= | CHOICE { |

| | |
|---|---|
| ssb | BFR-SSB-Resource, |
| csi-RS | BFR-CSIRS-Resource |

}

| | |
|---|---|
| BFR-SSB-Resource ::= | SEQUENCE { |

| | |
|---|---|
| ssb | SSB-Index, |

| | |
|---|---|
| ra-PreambleIndex | INTEGER (0..63), |

...
}

| | |
|---|---|
| BFR-CSIRS-Resource ::= | SEQUENCE { |

| | |
|---|---|
| csi-RS | NZP-CSI-RS-ResourceId, |

| | |
|---|---|
| ra-OccasionList | SEQUENCE (SIZE(1..maxRA-OccasionsPerCSIRS)) OF |

| | | |
|---|---|---|
| INTEGER (0..maxRA-Occasions-1) | OPTIONAL, | -- Need R |

| | |
|---|---|
| ra-PreambleIndex | INTEGER (0..63) |

OPTIONAL, -- Need R
...
}

| | |
|---|---|
| ZeroOutage-PRACH-ResourceDedicatedBFR ::= | CHOICE { |

| | |
|---|---|
| reference-orientation | Reference-Orientation, |

| | |
|---|---|
| ssb | ZeroOutage-BFR-SSB-Resource, |
| csi-RS | ZeroOutage-BFR-CSIRS-Resource |

}

| | |
|---|---|
| ZeroOutage-BFR-SSB-Resource ::= | SEQUENCE { |

| | |
|---|---|
| ssb | SSB-Index, |
| ssb-start-angle | SSB-Start-Angle |
| ssb-end-angle | SSB-End-Angle |
| priority | INTEGER (range from Lowest Priority to Highest Priority) |
| ra-PreambleIndex | INTEGER (0..63), |

...
}

| ZeroOutage-BFR-CSIRS-Resource ::= | | SEQUENCE { |
|---|---|---|
| csi-RS | NZP-CSI-RS-ResourceId, | |
| csi-RS-start-angle | CSI-RS-Start-Angle | |
| csi-RS-end-angle | CSI-RS-End-Angle | |
| priority | INTEGER (range from Lowest Priority to Highest Priority) | |
| ra-OccasionList | SEQUENCE (SIZE(1..maxRA-OccasionsPerCSIRS)) OF INTEGER | |
| (0..maxRA-Occasions-1) | OPTIONAL, | -- Need R |

| | |
|---|---|
| ra-PreambleIndex | INTEGER (0..63) |

OPTIONAL, -- Need R
...
}

| | |
|---|---|
| CandidateBeamRSListExt-r16 ::= | SEQUENCE (SIZE(1..maxNrofCandidateBeamsExt-r16) |

OF PRACH-ResourceDedicatedBFR
-- TAG-BEAMFAILURERECOVERYCONFIG-STOP
-- ASN1STOP

In this design, a single reference orientation may be provided for all beams contrary to the previous design where each candidate beam may be configured with its own reference orientation. Similar technique may be applied in this unified design to have a beam based reference specified.

Individual zero outage BFR and unified BFR configuration both may be defined for beams which are derived based upon SSB or CSI-RS signals. Similarly, the conditions for these measurement objects using SSB or CSI-RS may be defined using specific metrics e.g., RSRP, RSRQ and/or SINR etc. For ultra-massive MIMO, there may potentially be new reference symbol structures more suitable to resulting thousands of beams. These beams and relevant reference symbols may be transmitted in a hierarchical manner from the network. There may be multiple layers of such varying width beams. These ultra-massive and holographic MIMO beams may be suitably associated to potentially newly designed suitable reference symbols to provide zero outage BFR configurations to a WTRU. These new reference symbols may also follow the design and manner of transmission of such holographic beams. New measurement metrics may also be designed which capture the quality of a given beam in a more accurate and fast manner. For the hierarchical design, the quality of a beam may be derived based upon measurement over potentially overlapping/overlaid beams. The beam failure and recovery conditions and thresholds may be suitably defined and configured using the existing reference symbols or the new reference symbols defined for emerging networks having large number of beams, using existing or new metrics and suitable thresholds to be evaluated in view of those reference symbols and measurement quantities.

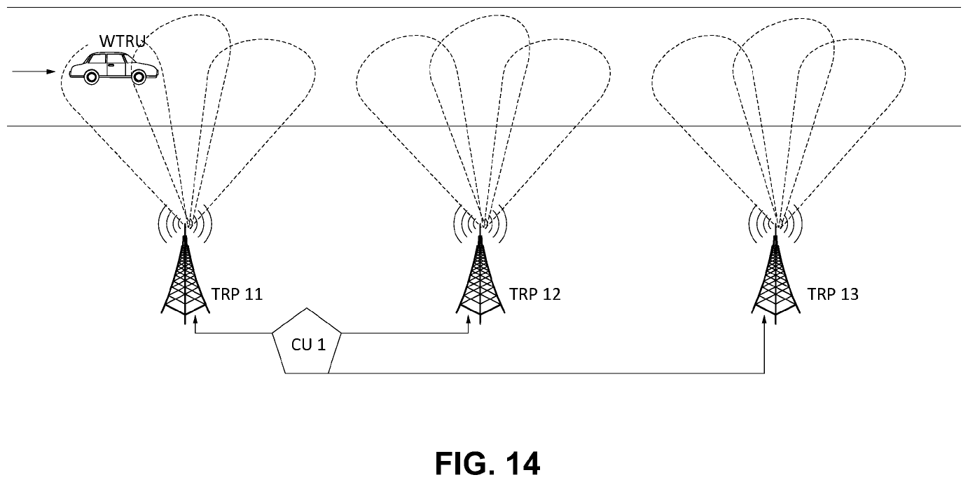

Zero outage BFR by network sharing a configuring a WTRU with a limited snapshot of neighboring beams may not be limited to scenarios where WTRUs/devices are undergoing rotational movements. In fact, the proposal may be fully applicable to rotational movements, translational movements, mobile blockers blocking a certain beam/link or beam/link failures due to other reasons, or any combination of the former mobility/blocking events. FIG. 14 shows a WTRU device inside a vehicle travelling on the road. This figure shows 3 TRPs each providing 3 beams to cover a part of the road stretch. The network may provide the beams configuration to the WTRU despite WTRU not being able to discover beams that it has not been in the coverage yet. To cover the translation movement, the beam recovery configuration may include the beam identities tied to location they are serving. This information may be communicated to the WTRU using its position and relative distance, or in terms of absolute positions for these beams which can be in terms of a suitable reference position and the beamwidth or cone of operation for each beam.

SSB and CSI-RS beams may indicate the active area individually where a reference direction can be indicated against which angular span is specified. In addition to the angular span, the translational coverage area may be specified using suitable coordinates. These coordinates may be the longitude and latitude for example as obtained through a GPS system. Suitable quantization may be applied to the indicated values to avoid the excessive overhead. The following unified zero outage BFR map for SSB and CSI-RS Beams example may provide the configuration structures where both ZeroOutage-BFR-SSB-Resource and ZeroOutage-BFR-CSI-RS-Resource provide the active beam area through the parameter ZeroOutage-BFR-Map which defines the active area through a set of parameters. In this example, ZeroOutage-BFR-Map may define the active beam area through beam-reference-orientation, beam-start-angle, beam-end-angle, beam-reference-position, and beam-active-span. Below is example pseudo code for a unified zero outage BFR map for SSB and CSI-RS beams.

| | |
|---|---|
| ZeroOutagePRACH-ResourceDedicatedBFR ::= | CHOICE { |

| | |
|---|---|
| ssb | ZeroOutage-BFR-SSB-Resource, |
| csi-RS | ZeroOutage-BFR-CSIRS-Resource |

}

| | |
|---|---|
| ZeroOutage-BFR-SSB-Resource ::= | SEQUENCE { |

| | |
|---|---|
| ssb | SSB-Index, |
| active-area | ZeroOutage-BFR-Mapping, |
| priority | INTEGER (range from Lowest Priority to Highest Priority) |

| | |
|---|---|
| ra-PreambleIndex | INTEGER (0..63), |

...
}

| | |
|---|---|
| ZeroOutage-BFR-CSIRS-Resource ::= | SEQUENCE { |

| | |
|---|---|
| csi-RS | NZP-CSI-RS-ResourceId, |

| | |
|---|---|
| active-area | ZeroOutage-BFR-Mapping, |
| priority | INTEGER (range from Lowest Priority to Highest Priority) |

| | |
|---|---|
| ra-OccasionList | SEQUENCE (SIZE(1..maxRA-OccasionsPerCSIRS)) OF |

| | | |
|---|---|---|
| INTEGER (0..maxRA-Occasions-1) | OPTIONAL, | -- Need R |

| | |
|---|---|
| ra-PreambleIndex | INTEGER (0..63) |

OPTIONAL, -- Need R
...
}

| | |
|---|---|
| ZeroOutage-BFR-Mapping ::= | SEQUENCE { |
| beam-reference-orientation | Reference-Orientation [in suitable coordinates] |
| beam-start-angle | BEAM-Start-Angle |
| beam-end-angle | BEAM-End-Angle |
| beam-reference-position | Reference-Position [in suitable coordinates or Zones] |
| beam-Active-SPAN | Active-Span [in suitable geogrphaic coordinates or |

Zones]
...
}

In ZeroOutage-BFR-Mapping parameter structure, each candidate beam additionally may have a Reference-Position and Active-Span indicated. This may enable mapping of a given beam to a certain geographic area with a certain angular span. This configuration may be suitably used in many of the real world situations that we encounter today and were highlighted in the problem formulation as a combination of high mobility, large number of beams, and limited discovery/feedback opportunities. Further refinements to beam geographic coordinates and areas may be added in Zero-Outage-BFR-Mapping struct to make it granular to the suitable extent and to have the coverage of the desired geographic spatial coordinates.

In the proposed embodiments in which the gNB configures a WTRU with the candidate beams for beam recovery procedure different suitable reference points may be used to indicate the angular span of a candidate beam and to indicate the active translational area. To indicate the angular span of a candidate beam, the reference direction may be taken to be the serving beam of the gNB. In another design, the reference direction may be taken to be the one of the directions from the cardinal directions. The configuration of reference beam may be given in terms of TCI state containing the reference DL/UL beam or associated RS.

To indicate the active translational area for a candidate beam, this area may be indicated in terms of absolute GPS coordinates. In a different design, the active translational area may be specified with respect to a suitable reference location/position. This reference may be the position of the gNB, which can also be indicated as part of the configuration. The current position of the WTRU may be taken as reference point. In a different design, when different beams are originating from different TRPs, the network may configure the position of the source TRP along with the candidate beam. With this information, a WTRU may determine the strongest beam with the assumption of line of sight which can be quite reasonable for communication at high frequencies.

Most of the steps of the proposed embodiment, relating to providing the WTRU assistance information, the network configuration of candidate beams, WTRU evaluation of the configured beams using the network provided geographic coordinates may stay valid for the beam failure recovery procedure triggered after beam failure detection for an SpCell or an SCell. As WTRU does not need to transmit RACH for BFR on an SCell, the zero outage BFR configuration provided for an SCell may not include RACH preambles and relevant parameters. From WTRU action perspective, once a WTRU identifies the most suitable candidate beam for BFR, the WTRU may prepare a set of validated candidate beams and prepare a MAC CE, either BFR or truncated BFR. For beam recovery procedure on an SpCell, the WTRU may transmit RACH according to the configured parameters and may transmit the MAC CE as part of the RACH transmission.

For beam recovery procedure on an SCell, a WTRU may transmit BFR or truncated BFR MAC CE to the network on the special cell which is the primary cell of the relevant cell group. Even this procedure may get a significant latency benefit from WTRU being able to quickly determine the best beam thanks to the proposed solution where mapping of candidate beams is provided with respect to the suitable geographic coordinates and can be made richer and more granular using the information from local sensors potentially combined with radio measurements. Zero outage BFR configuration for SCell may be specified similar to earlier proposed configuration variations for SpCell. In a normal design of BFR configuration for an SCell, RACH relevant details may not be provided. Nevertheless, in the proposed approach, SCells may be configured for RACH transmission, and if so, the BFR configuration for such SCells may comprise of relevant RACH parameters.

To make BFR quicker for both SpCell and SCell, beam failure detection may be declared earlier or with larger thresholds compared to the legacy beam failure detection parameters when the WTRU is configured with zero outage beam failure recovery candidates. For this purpose, two sets of thresholds may be indicated for beam failure detection. One set of thresholds may be the legacy beam failure detection threshold, and a new more stringent threshold may only apply when the WTRU has zero outage configuration available. Beyond thresholds, new conditions or new events may be defined more relevant for zero outage BFR.

An exemplary embodiment specifying a procedure for a WTRU to have zero outage while undergoing beam failure recovery procedure may comprise the following steps. The steps may include that (1) the WTRU sends the zero outage Assistance Information to the gNB, as shown in 1204 and 1304, (2) the gNB prepares a suitable Unified zero outage BFR configuration based upon the received assistance information from the WTRU and the network deployment of its TRPs, cells and beam, and transmits this configuration to the WTRU, (3) the WTRU receives a configuration from the gNB for the zero outage BFR, as shown in 1206 and 1306, (4) on a condition when the WTRU detects Beam Failure (configured reference signals of the serving beam fall below a configured threshold or conditions of BFD fulfilled), the WTRU starts the beam failure recovery procedure, (5) the WTRU gets the information from local sensors (GPS, Accelerometer, Gyroscope etc.) potentially combined with radio measurements, as shown in 1208 and 1308, (6) the WTRU evaluates the change in local sensors data and configured conditions to determine device mobility or external mobility as per the configuration to determine Device Mobility or External Mobility, as shown in 1210 and 1310, (7) the WTRU selects the highest priority beam among the determined candidates, as shown in 1214, 1224, 1314, and 1324, (8) the WTRU activates the antenna panel associated to the selected BFR candidate, (9) the WTRU measures the quality of the selected BFR candidate beam using the configured measurement signal(s) and the configured threshold(s), as shown in 1216, 1226, 1316, and 1326. The zero outage Assistance Information sent to the gNB may include radio-measurement-quantity-based-data, non-radio-measurement-quantity-based-data, and/or WTRU-capability-and-Implementation-details. The configuration received from the gNB for the zero outage BFR may include a single configuration covering device mobility and external mobility. The single configuration covering device mobility and external mobility may include parameters. The parameters may include, for example, set of candidate beams, candidate beams associated to suitable SSB, CSI-RS or newly designed reference signals, RACH parameters associated to each candidate beam, mapping of candidate beams to suitable geographic coordinates (location, position, orientation) to accommodate Device Mobility and External Mobility, and/or indication of priority for candidate beams when multiple candidate beams may have at least partial overlap for certain geographic coordinates. When the WTRU determines there is Device Mobility, the WTRU may determine the candidate beams as recovery Candidate from the configured mapping table using its determined geographic coordinates (position/location and orientation etc.) and radio measurements. When the WTRU determines there is External Mobility, the WTRU may determine the candidate beams as recovery Candidate from the configured mapping table using its determined geographic coordinates (position/location and orientation etc.). Determining the candidate beam(s) may include removing the beam over which beam failure detection occurs from candidate set in case of external mobility.

The Beam Failure Recovery may be for an SpCell. On a condition when the selected candidate passes the quality criterion, the WTRU may extract its associated RACH configuration parameters. The WTRU may transmit RACH for the BFR candidate using the derived RACH parameters. The WTRU may prepare and transmit BFR MAC-CE providing the information of the suitable candidate beam(s) to the network.

The Beam Failure Recovery may be for an SCell. On a condition when the selected candidate passes the quality criterion, the WTRU may prepare the BFR MAC-CE. The WTRU may transmits BFR MAC-CE to the network.

An exemplary embodiment specifying a procedure for the WTRU to have zero outage while undergoing beam failure recovery procedure may comprise the following steps. The actions may include (1) the WTRU sends the zero outage Assistance Information to the gNB, (2) the gNB prepares multiple suitable zero outage BFR configurations based upon the received assistance information from a WTRU, WTRU profile, and the network deployment of its TRPs, cells and beam, and transmits this configuration to the WTRU, (3) the WTRU receives the configuration set from the gNB for the zero outage BFR, (4) on a condition when the WTRU detects Beam Failure (configured reference signals of the serving beam fall below a configured threshold or conditions of BFD fulfilled), the WTRU starts the beam failure recovery procedure, (5) the WTRU gets the information from local sensors (GPS, Accelerometer, Gyroscope etc.) potentially combined with radio measurements, (6) the WTRU evaluates the change in local sensors data and configured conditions to determine device mobility or external mobility as per the configuration to determine Device Mobility or External Mobility, (7) the WTRU selects the highest priority beam among the determined candidates, (8) the WTRU activates the antenna panel associated to the selected BFR candidate, (9) the WTRU measures the quality of the selected BFR candidate beam using the configured measurement signal(s) and the configured threshold(s). The zero outage Assistance Information to the gNB may include radio-measurement-quantity-based-data, non-radio-measurement-quantity-based-data, and/or WTRU-capability-and-Implementation-details. The configuration set received from the gNB for the zero outage BFR may include two configurations for device mobility and external mobility. Each one configuration of device mobility and external mobility may include parameters. The parameters may include, for example, set of candidate beams/TRPs, candidate beams associated to suitable SSB, CSI-RS or newly designed reference signals, RACH parameters associated to each candidate beam, mapping of candidate TRPs/beams to location/position, orientation for Device Mobility, mapping of candidate TRPs/beams for External Mobility, and/or indication of priority for candidate beams when multiple candidate beams may have at least partial overlap for certain geographic coordinates. If the WTRU determines Device Mobility, the WTRU may select the Device Mobility BFR configuration. The WTRU may determine the candidate beams as recovery Candidate from the selected configuration mapping table using its determined geographic coordinates (position/location and orientation etc.) and radio measurements. If the WTRU determines External Mobility, the WTRU may select the External Mobility BFR configuration. The WTRU may determine the candidate beams as recovery Candidate from the selected configuration mapping table using its determined geographic coordinates (position/location and orientation etc.). Determining the candidate beam(s) may include removing the beam over which beam failure detection occurs from a candidate set in case of external mobility.

Beam Failure Recovery may be for an SpCell. On a condition when the selected candidate passes the quality criterion, the WTRU may extract its associated RACH configuration parameters. The WTRU may transmit RACH for the BFR candidate using the derived RACH parameters. The WTRU may prepare and transmit BFR MAC-CE providing the information of the suitable candidate beam(s) to the network.

Beam Failure Recovery may be for on SCell. On a condition when the selected candidate passes the quality criterion, the WTRU may prepare the BFR MAC-CE. The WTRU may transmit BFR MAC-CE to the network.

In an example embodiment, zero outage conditional handover may be performed. 3GPP has defined conditional handover (CHO) procedure where the WTRU is provided with the configuration of candidate cells for CHO with execution conditions. When the execution condition for a candidate CHO cell gets satisfied, the WTRU may start handover procedure with that candidate cell. This process may provide shielding against the issue of legacy handover where if the current serving cell undergoes fast failure. The WTRU may not be able to complete the handover signaling exchanges with the source cell resulting in handover failure. For one example, legacy handover failure may happen while the WTRU is providing the measurements to the source cell. For another example, legacy handover failure may happen while the source cell is providing the handover configuration to the WTRU. If legacy handover failure happens, the WTRU may need to perform the RRC connection re-establishment or eventually cell selection both resulting in latencies and outages far exceeding the QoS requirements for the future applications.

The proposed solution for zero outage conditional handover may be trying to achieve predictive mobility. As cellular networks are planned networks, the network may have precise knowledge of its deployment of cells, and the beams within those cells. What network may not know is how a specific WTRU moves from one cell/beam to another cell/beam. As a matter of fact, this information is in general not even known to the WTRU itself. In general, the WTRU may have no information of network deployment in terms of cells and beams and the geographic areas where these cells/beams are active. On the contrary, the WTRU may be equipped with many local sensors and may have additional interfaces and connections to other RATs/devices around with which tracks its movements and determines its new geographic coordinates and orientation in a very fast manner.

The proposed approach may target combining (i) the knowledge of network deployment of cells/beams and (ii) the ability of the WTRU to track its movements and determine updated geographic location/position and orientation. The network shares a suitable finite piece of its deployment relevant to the WTRU based upon assistance information received from this WTRU. The shared piece of network deployment may comprise of neighboring cells and relevant beams provided with a mapping of these (cell, beam) pairs to suitable geographic coordinates. The configuration may include the execution conditions to perform conditional handover to the configured (cell, beam) pairs. In case of degradation over the serving link quality, the WTRU may use the information from local sensors and interfaces to extract its current geographic coordinates and orientation. With these parameters, the WTRU may determine the suitable conditional handover candidate (cell, beam) pair from the network provided configuration. The configuration parameters provide the quality criterion and execution conditions for the candidate (cell, beam) pairs along with their RACH configuration. If the execution conditions are fulfilled, the WTRU may initiate conditional handover to the candidate (cell, beam) pair. The deterministic derivation of suitable candidate (cell, beam) may pair with the updated geographic coordinates leads to WTRU mobility management with seamless handovers and minimal interruptions.

The assistance information from the WTRU may be broadly categorized in two groups, termed as measurement based data and non-measurement-based data. One group of the assistance information may comprise of all the information that can be estimated, measured, determined with or without post-processing over the signals received from the radio interface where mobility is being considered. This group may be termed as measurement-based data. The measurement-based data may comprise of receiving, measuring, and processing the reference signals on the physical layer, MAC information elements, RRC messages received from the network, or the information received at higher layers. The second group of the assistance information may comprise of all the information that is not extracted from the network signaling. This group may be termed as non-measurement-based data. One sub-group in non-measurement-based data may comprise of the WTRU capability and implementation details covering its antenna panels, respective field-of-views for those panels, transceivers, and power characteristics, switching delays, simultaneous operation for the panels etc. The second sub-group in non-measurement-based data may encompass all the information extracted or measured through local sensors and interfaces other than the radio interface where mobility is being considered. Examples of local sensors may include positioning sensors, gyroscopes, accelerometers etc. The interfaces other than the considered radio interface may be wired interfaces like ethernet, wireless interfaces like Bluetooth, WIFI or any other proprietary wired or wireless interfaces. Yet another sub-group in non-measurement-based data may comprise of the mobility metrics and configurational triggers. Examples of mobility metrics may be the speed, velocity, and history of mobility to name a few. The relevant configurational triggers helpful for mobility management and providing the suitable configuration may come from situational or contextual information. For example, a vehicular device (or the devices inside) may start its trajectory to a destination where both the start and the trajectory could be very important from the configuration perspective. Another example may be the start of a network game from an AR/VR device potentially including user profile which incorporates or provides the user behavior in terms of rotations during the game. Such parameters may also be updated by a WTRU while having received some BFR configuration from the gNB. The gNB may also update the BFR configuration upon receiving the updated assistance information from the WTRU or other factors.

The assistance information may be categorized in different groups and sub-groups. The method proposed here may target conditional handover with zero outage. The summary of the steps of this approach may include the following steps.

The first step may include that the WTRU provides assistance information regarding its position/location/panels/FoV/Application-QoS to the gNb. This assistance information may incorporate and streamline the potential information originating from advanced sensors which are used by the WTRU and provided to the gNB. The examples of such information may be the information generated through positioning sensors, gyroscopes, and accelerometers. The WTRU may update its assistance information, at least for certain parameters under certain conditions.

The second step may include that the gNB provides the zero-outage conditional handover configuration in response to the WTRU assistance information. This configuration may be based upon the network deployment of cells, TRPs, beams and WTRU provided assistance information. The configuration preparation may take into account any historical data about WTRU parameters, applications usage, WTRU subscription status etc. The configuration preparation may use the artificial intelligence and machine learning algorithms to prepare the configuration suitable to the WTRU in a predictive manner using all the network and WTRU data.

The third step may include that the zero-outage conditional handover configuration comprises of a set of candidate cells. For each cell, relevant beam indices may be provided. For each (cell, beam) pair, the mapping of the pair to suitable active zones (position/location, angular span, WTRU Panel) may be provided where this cell/beam pair is used for conditional handover. The execution conditions may also be provided as part of the configuration for each (cell, beam) pair. When multiple pairs are indicated for a given location and angular span, the priority for (cell, beam) pair may be provided as part of the configuration. For each candidate (cell, beam) pair, the configuration may provide suitable RACH preambles and other RAC configuration parameters.

The fourth step may include that the WTRU extracts the information from its local sensors after a mobility event (resulting from device mobility or mobility in the environment) leading to compromised link quality. The WTRU may combine suitable information elements from measurement-based-data and non-measurement-based-data. From its estimated geographic coordinates and orientation, The WTRU may derive the highest priority (cell, beam) pair from the network configured mapping which are mapped to its estimated geographical coordinates.

The fifth step may include that the WTRU evaluates the execution condition for the determined (cell, beam) pair as per the network provided configuration. If the evaluation result fulfills, the WTRU may perform conditional handover to the determined candidate (cell, beam) pair using the configured RACH parameters.

Procedural details for zero outage conditional handover are discussed. The WTRU may have limited discovery of neighboring cells/gNBs around it due to ultra-massive MIMO beam deployments, higher mobility, special conditions in terms of nature of the objects placements and blocking on the ground, limited number of antennas, antenna panels, transceivers, or stringent requirements on power consumption. This may result in limited or no neighboring cells being discovered and reported by the WTRU to the network. With the legacy handover and conditional handover procedures where the network configurations are typically based upon WTRU reporting, the configurations from the network and mobility aggravated by rotation may land the WTRU in the angular coverage of a beam of a new gNB that it was not able to discover and report to the network. The most suitable (cell, beam) may change much faster for the future deployments of ultra-massive MIMO beams and if each such change requires network configuration and exchanges with the network, the resulting overhead may be exorbitant. The proposed zero outage conditional handover provides a mechanism to avoid frequent and larger interruptions for such scenarios.

In an example embodiment, the WTRU may provide assistance information to the gNB. This information may comprise of the measurement-based data and non-measurement-based data as detailed earlier. The base station may indicate the WTRU a set of gNBs near the WTRU's actual position along with their suitable coverage areas. The suitable coverage area may include an indication in terms of position and orientation. The position may cover the translational mobility that the WTRU can have. The translation mobility may be associated with each configured beam belonging to a neighboring cell/gNB. The translation mobility indication may be with reference to the actual position of the WTRU. Another method may be to provide the translation mobility indication in terms of absolute position. The absolute position may be the GPS coordinates which are associated with each beam of each configured cell/gNB.

The orientation indication may cover the rotational movement of the WTRU which can happen with or without a translational movement. The orientation indication may be provided for one or multiple beams from each configured gNB. The orientation indication may be in the form of angular coverage with respect to a suitable reference direction. The reference beam indication may be part of the configuration. The reference beam may be defined as an SSB beam or a CSI-RS beam. In addition, the reference beam may be the actual beam through which the network is serving the WTRU. Instead of reference beam, reference direction may be specified using other approaches, e.g., geographical north or some other reference which is understandable to both the network and the WTRU. In one example, the orientation information may be given with respect to one or more configured TCI states where a TCI state may contain QCL reference information with a DL or UL beam/RS of a cell.

For each (cell, beam) pair in the configured conditional Handover set, in addition to its angular span around the WTRU, the network may provide the relevant parameters to trigger conditional handover. These parameters may comprise of contention free RACH preambles within that beam. This may include the RACH parameters, e.g., RACH preamble sequence identity, RACH duration, power ramping parameters, the parameters related to RACH occasions associated to the indicated beam, etc.

In a compatible design solution, the configuration may also include the conditions under which the configuration stays valid. The configuration may have a timer and the validity may expire upon the expiry of this timer. Another configuration release condition may be associated with the mobility. For example, if the configured device moves away from its last known position/location by more than a configured threshold, it may release the configuration. For one example, the WTRU may release the configuration if it just moves out of its current zone. In another example, the configuration may be valid in the current zone and direct neighbors having overlapping boundaries. In this case, if the WTRU moves out of direct neighbor zones, it may release the configuration. Another example where the configuration release condition may be associated with the device's timing advance value (e.g., with the serving gNB). For example, if the device moves and the change in the timing advance Is above a configured threshold, the device may be configured to release the current active configuration. More broadly, any suitable combination of parameters from the assistance information may be used to define the validity conditions and the release conditions.

In another solution, one or more configurations may be given to the device. The mapping/association of a configuration with a zone, a location, or a timing advance value/range may be given to the device. The device may select the configuration based on the tracking of the associated metric (zone, location, or timing advance, etc.).

For systems based upon ultra-massive MIMO having the capability of deploying thousands of beams per TRP, to contain the signaling overhead the network deployment of beams may follow certain rules. The rules may be provided to the WTRU in a compact form. In one example, the beam deployment for from a TRP may follow a pattern in azimuthal and elevation dimensions. A set of patterns may be known in tabular forms or through formulae. The network may choose a suitable pattern for its deployment according to its requirements in a given geographic area. For such cells and beam deployments, the network may provide the compact form of deployment pattern to the WTRU as part of the zero outage conditional handover configuration. The configuration may include the positions of TRPs in suitable coordinates for candidate (cell, beam) pairs. The WTRU receiving such configuration may determine the nearest TRPs for any location relevant for each candidate (cell, beam) pair and then determine the suitable candidate (cell, beam) matching its updated geographic coordinates.

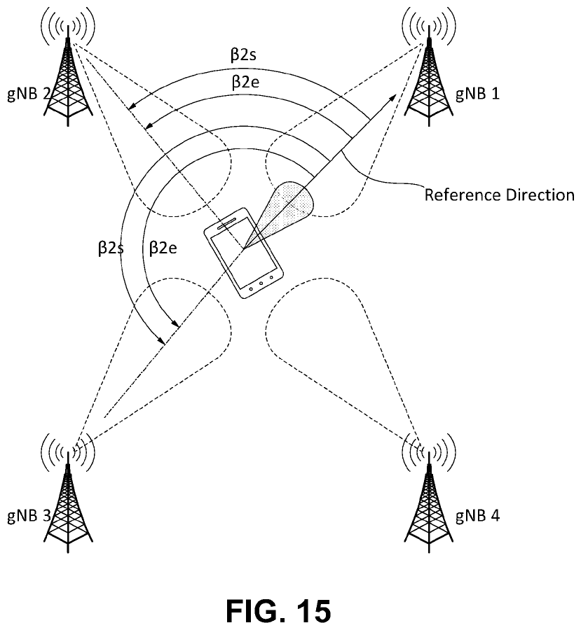

An example configuration for a WTRU rotation scenario is shown in FIG. 15 for the WTRU communicating with gNB 1. This figure may show the configuration comprising of indication of reference direction with the current beam, and the neighboring cells/beams with their spans. In this example figure, a beam from gNB 2 may be configured with its span marked with respect to the reference (beam) direction as a start angle (β2s) and an end angle (β2e). Similarly, the figure may show the start and end angles for an exemplary beam from gNB 3 as β3s and β3e. For each configured candidate (cell, beam) pair, the gNB provides the RACH related details to allow contention free RACH access (CFRA) within that (cell, beam) pair.

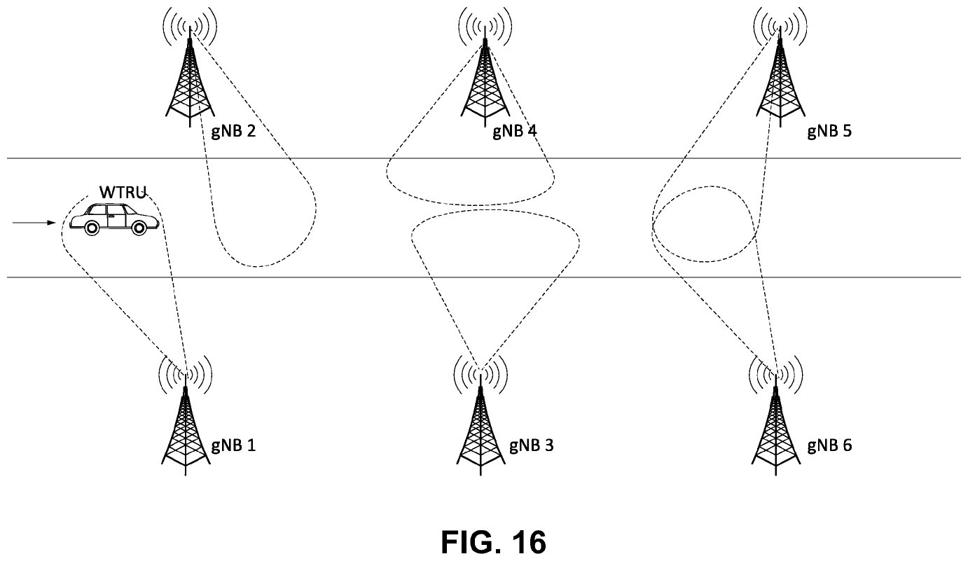

FIG. 16 may show another example scenario where a WTRU is configured by the network with multiple CHO candidates to combat both translational and rotational motion. In this case, the WTRU may be configured with CHO configuration from different gNBs with location/position of the WTRU and orientation and a mapping to the candidate CHO cells such that the WTRU determines the suitable beam/gNB to attach using the mobility information from its local sensors. The location/position and angular span may be provided with reference to the WTRU position and orientation.

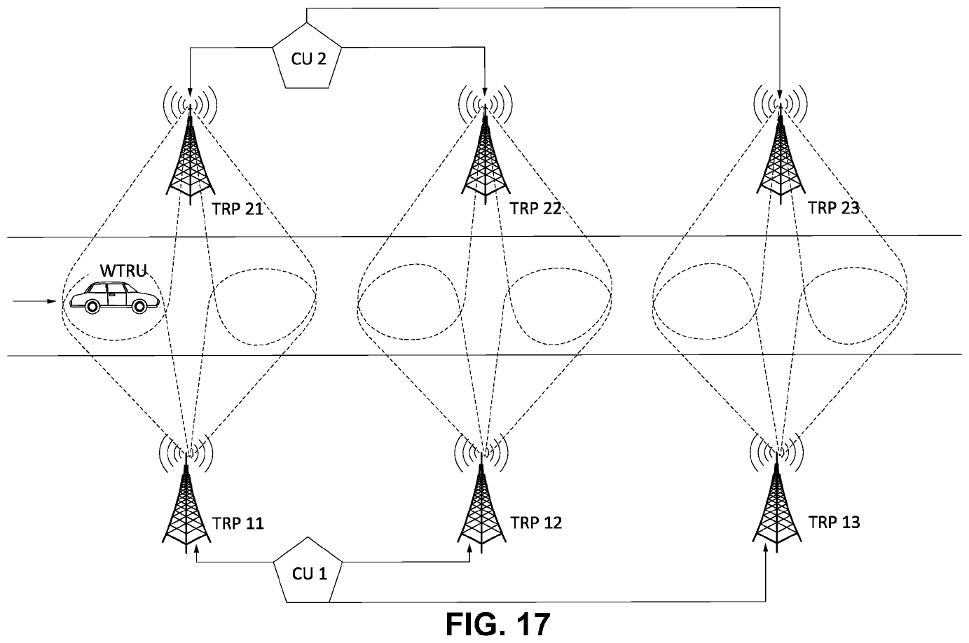

FIG. 17 may show an exemplary scenario where a WTRU in moving on a road in a car. This WTRU may face situations where it crosses beams from a single TRP, beams from one TRP to a neighboring TRP controlled by the same control unit (CU), and moving from one beam of a given TRP to a beam from a different TRP under a different CU. The figure may show the scenario where beams/cells switching takes place as a result of translational motion, rotation, or a combination. The WTRU may be provided with zero outage beam failure recovery configuration and zero outage conditional handover configuration. These configurations may let the target WTRU monitor its mobility status through the information obtained from its local sensors potentially confirmed through the over-the-air measurements and perform zero outage beam recovery and zero outage CHO avoiding any outages while it may be moving very fast and traversing the beams and cells.

If the WTRU undergoes compromised link quality, the WTRU may extract the information from local sensors. The WTRU may combine this with other radio measurements. Translation movement information may, for example, come from the local GPS receiver. The rotational movement may come from gyroscope or other components. The WTRU may compute its new geographic coordinates and orientation. The new geographic coordinates and orientation may be used to find the suitable candidate (cell, beam) pair from the network provided mapping of (cell, beam) pairs and geographic coordinates and orientation. This may let the WTRU know precisely which beam of a suitable cell from a suitable gNB it should have line-of-sight connection with respect to its updated coordinates. As a result, the WTRU may not need to perform blind cell searches to find which beams of which cells will be active and suitable after undergoing a mobility event.

After having derived the suitable (cell, beam) pair from the network provided configuration, the WTRU may evaluate the CHO condition with this target candidate pair. If the CHO trigger condition is satisfied, the WTRU may send contention free RACH with the configured RACH parameters over the configured RACH resources provided as part of the determined candidate (cell, beam) pair, as shown in 1818 and 1828.

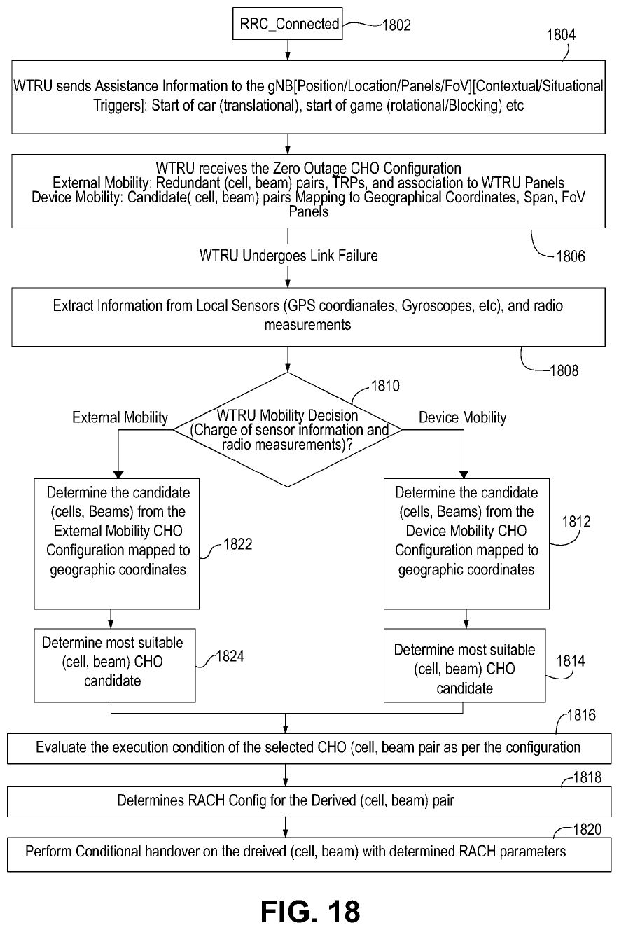

FIG. 18 depicts an example flow chart for zero outage conditional handover. For the WTRU in RRC_CONNECTED state (1802), the WTRU may send the advanced Assistance Information to the network/gNB (1804). This information from the WTRU may include the information from local sensors, e.g., position sensors, gyroscope, accelerometer etc. Additional groups and constituent elements for the WTRU assistance information were discussed earlier.

Based upon the WTRU assistance information, network deployment of TRPs, cells and beams, WTRU profile for services and mobility, QoS requirements for the services/applications a WTRU is using, the network may provide suitable configuration to WTRU for zero outage CHO (1806). This configuration may comprise of the candidate cells and beams and suitable mapping of these candidate (cell, beam) pairs to suitable geographic coordinates and orientations. The configuration also may comprise of the parameters and thresholds for the WTRU to derive its zone/location/position and span, so as to determine the suitable (cell, beam) pair from the mapping table. The configuration may provide two sets of sub-configurations, one to handle the device mobility where the device is undergoing translational and rotational movements, and the other sub-configuration focusing on the external mobility where the interruptions is originated from the environment and not the result of direct device mobility. As an example, the external mobility resulting from mobile blockers may provide the (cell, beam) pairs which are able to provide the coverage to the target device with its known location/position at the network when the serving cell degrades or undergoes failure. This step may require the WTRU/device switching and activating to a different panel which gNB may provide the indication as part of configuration. This indication is in turn based upon the WTRU may provide the Implementation and capabilities of its antenna panels and detailed feature set as part of its assistance information.

In a compatible approach, the network may provide a set of CHO configurations to the WTRU. The network may provide the association of these configurations to different suitable criteria. These may include but not limited to WTRU active applications, QoS for example different reliability requirements, different power consumption targets at the WTRU, WTRU active service subscription level etc. When the WTRU is undergoing link failure or compromised link quality, the WTRU may use the suitable configuration according to the current situation as per the configured criterion. As described earlier, the multiple configurations may be associated to different physical parameters (like external or device mobility), different service reliability targets (one configuration while higher reliability is required and once configuration for lower reliability), different subscription levels (one configuration when WTRU is using paid content vs one configuration for the non-paid-content) etc.

When the WTRU is facing a compromised link quality according to the configured quality threshold(s), the WTRU may extract the information from its local sensors (1808). The sensors information may be combined with measurements performed using the new or existing reference signals received from the network. One example may be to combine them with measurements performed using the downlink positioning reference signals. The WTRU may decide the nature of mobility (1810). The WTRU may use this information to select the suitable (cell, beam) candidate pair from the device mobility (1812) or external mobility configuration (1822). The WTRU may map the information from local sensors to the suitable format of location/zone/orientation as per the selected suitable configuration and then derives its location/orientation. With this location/orientation, the WTRU may determine the suitable (cell, beam) pair from the configured mapping.

The entries in the mapping table may provide multiple candidate (cell, beam) pairs for a given location/orientation. In this case, the network configuration may provide priority order for the candidate (cell, beam) pair. The WTRU may select the most suitable candidate for external mobility (1824) or device mobility (1814). In a compatible design, the priority for the multiple pairs for a given location and angular span may be left to WTRU implementation. The WTRU may then evaluate the configured CHO execution condition as per the configuration (1816). The WTRU may determine the RACH configuration for the determined CHO candidate (1818) and performs CHO (1820) to the determined target. The execution conditions may be specified through suitable configuration of conditional event A3 and conditional event A5. Conditional event A3 may be defined as a case when a candidate CHO cell (with a suitable beam) becomes offset better than current SpCell, primary cell of the master cell group or the primary cell of the secondary cell group. Conditional event A5 may be defined with two absolute conditions. One condition may be defined for the SpCell to become worse than a configured threshold, and the second condition may be specified for the CHO candidate to become better than another configured threshold. For the target use cases spanning ultra-massive MIMO beams having variety of deployment possibilities including layered and hierarchical architectures, new reference signals may be designed to suitably and rapidly identify, detect and measure such beams. These reference signals may then be used to identify (cell, beam) pairs and are provided as part of network configuration. The quality criterion and CHO execution conditions (conditional A3/A5 or newly designed) may then be specified in terms of new reference signals.

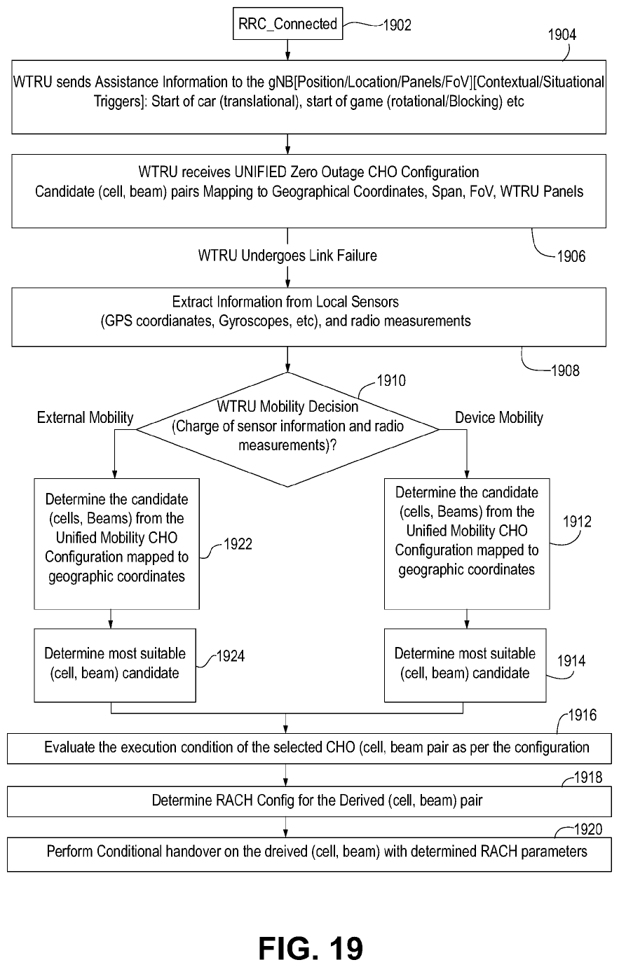

In a compatible design to enable zero outage conditional handover, the configuration for candidate (cell, beam) pairs may be provided as a unified configuration, as depicted in FIG. 19. FIG. 19 depicts another example flow chart for zero outage conditional handover. In this unified configuration, all the candidates and their priorities may be provided with their mapping to suitable geographic coordinates, orientations, and association with other parameters the WTRU can extract and use to determine the suitable CHO candidate. FIG. 19 shows a flowchart for zero outage conditional handover with a key change compared to the previous figure that the network configuration for CHO candidates is provided in a unified manner (1906), encompassing the candidates targeting external mobility and device mobility.

For the WTRU in RRC_CONNECTED state (1902), the WTRU may send the advanced Assistance Information to the network/gNB (1904). Once the WTRU is undergoing link failure situation or the quality of the serving link is falling below a configured threshold, the WTRU may get the information from its local sensors (1908) to decide whether the link failure is happening due to device mobility or external mobility (1910). This information combined with other sensor's information; the WTRU may pick the suitable CHO configurations (1922) for external mobility case and (1912) for device mobility case. In case of multiple candidate configurations, the WTRU may select the most suitable candidate (1924) for external mobility or (1914) for device mobility. To initiate conditional handover to the most suitable CHO candidate, the WTRU may need to activate a different antenna panel as per the selected configuration. With suitable antenna (panel) activated, the WTRU may evaluate the execution condition for the selected CHO candidate (1916). The CHO execution condition may be configured in terms of RSRP, RSRQ or SINR using suitable indicated measurement objects. In addition, the CHO configurations may provide same or different execution conditions for different CHO candidates. If the selected CHO candidate satisfies the execution condition, the WTRU may select the RACH configuration (1918) associated to the selected (cell, beam) candidate and transmits RACH as part of the CHO initiation (1920). This may trigger basically the fast attach procedure to the CHO candidate.

To enable zero outage CHO, the network configuration may include the suitable CHO candidate (cell, beam) pairs. Along with a mapping may be provided of these CHO candidates to suitable geographic coordinates and orientations. In an example embodiment, the geographic coordinates (such as location/position) and orientation/angular-span coordinates for the (cell, beam) pairs may be provided with respect to the WTRU position and a reference direction. The reference direction may be with respect to one of the cardinal directions, or it could be specified with respect to the current serving beam, or another suitable reference. With this design, the CHO candidates (the neighboring cells) may be provided with distance and orientation parameters which allow the WTRU to determine the active area where it can suitably attach to these candidates.

In a compatible design for zero outage CHO, the configuration of candidate CHO (cell, beam) pairs may provide the location of network node (DU, TRP, gNB) transmitting these candidates. The configuration may additionally include the orientation/angular-span of the beams associated to these nodes using suitable coordinates and references. The WTRU knowing the location/position of a set of nodes transmitting candidate CHO cells may determine the strongest (nearest) node knowing its own location/position which can be obtained through local sensors. In certain settings, the data of local sensors may be augmented by the suitable radio measurements. To cover the special geographic settings or known shadowing, the network may provide priorities to be used in addition to the nearest node selection or suitable offsets to be employed in computing the nearest node. The orientation for a (cell, beam) pair may be indicated with respect to a suitable reference which is understandable at the WTRU. The orientation reference may be with respect to a global or local coordinate system. In yet another design to provide orientation indication, the reference direction for the orientation may itself be part of the configuration. For example, the network may indicate that the reference direction is cardinal north (or a different cardinal direction) and all the angular spans for the beams may be provided with respect to this reference direction. In a different example, the reference direction may be with respect to serving beam of the serving node through which the network provides the configuration of zero outage CHO. The reference direction may later be updated by the network if necessary.

For legacy CHO, 3GPP may use the IE CondReconfigToAddModList which provides a list of conditional reconfigurations to add or modify, with for each entry the condReconfigId and the associated condExecutionCond and condRRCReconfig. This may allow the network to add a cell as a CHO candidate. For the proposed solution of zero outage CHO, a more feature rich information element (IE) ZeroOutageCondReconfigToAddModList may be specified which provides the zero outage configuration for the candidate (cell, beam) pairs to the WTRU by providing additional mapping of candidate (cell, beam) pairs to geographic coordinates and orientation in suitable format. ZeroOutageCondReconfigToAddMod may provide the zero outage CHO configuration candidates to be added or modified with corresponding execution conditions. Below is example pseudo code for a zero outage conditional handover configuration.

ZeroOutageCondReconfigToAddModList ::= SEQUENCE (SIZE (1..
maxNrofZeroOutageCondCells-r16)) OF ZeroOutageCondReconfigToAddMod

| | |
|---|---|
| ZeroOutageCondReconfigToAddMod ::= | SEQUENCE { |

| | |
|---|---|
| zeroOutageCondReconfigId | ZeroOutageCondReconfigId, |
| zeroOutageCondExecutionCond | SEQUENCE (SIZE (1..2)) OF MeasId |

OPTIONAL, -- Cond condReconfigAdd

| | |
|---|---|
| zeroOutageCondRRCReconfig | OCTET STRING (CONTAINING |

| | |
|---|---|
| RRCReconfiguration) OPTIONAL, | -- Cond condReconfigAdd |

...
}
-- TAG-CONDRECONFIGTOADDMODLIST-STOP
-- ASN1STOP

In one design to realize the zero outage CHO, the beams associated to each CHO cell and their mappings to suitable geographic coordinates and orientations may be added in RRCReconfiguration. This may be achieved by adding the new information elements as part of RRCConfiguration which provides the mapping of cell beams to geographic coordinates. Similar information elements may be added as part of zero outage beam failure recovery configuration, namely ZeroOutagePRACH-ResourceDedicatedBFR, ZeroOutage-BFR-SSB-Resource, ZeroOutage-BFR-CSIRS-Resource, ZeroOutage-BFR-Mapping etc. The network may choose which beams either SSB, or CSI-RS based, or based upon new reference symbols used to identify such beams to configure as part of each candidate CHO cell.

In a different yet compatible design, RRCReconfiguration may be kept unchanged, and the relevant beams associated to a given CHO candidate cell and mappings for each zero outage CHO candidate (cell, beam) pair may be added in ZeroOutageCondReconfigToAddMod IE using suitable structures providing the beams for each candidate cell and the active zone associated to each (cell, beam) pair. The example design below may add a struct zeroOutageCHOBeamList to zero outage CHO configuration. This may provide a mechanism to the network to pre-configure all the suitable (SSB and CSI-RS) beams for a candidate CHO cell to the WTRU. As part of this configuration, ZeroOutage-CHO-BeamMapping may be configured for each configured beam for a candidate CHO cell. This may provide in turn the mapping of a configured beam of a configured CHO candidate to suitable geographic coordinates and orientation. In the configuration shown below, the beams may be specified for each CHO candidate and RACH occasion and PRACH preamble indices are also specified per beam. The configuration may be simplified by associating RACH configuration to cell level configuration, though beam level configuration allows quick determination at the network which the WTRU is using a given CHO (cell, beam) pair for CHO. Most of the parameters in the following example configuration may have been described earlier in the context of zero outage beam failure recovery configuration. Below is example pseudo code for a zero outage conditional reconfiguration to an addition/modification list element.

ZeroOutageCondReconfigToAddModList ::= SEQUENCE (SIZE (1..
maxNrofZeroOutageCondCells-r16)) OF ZeroOutageCondReconfigToAddMod

| | |
|---|---|
| ZeroOutageCondReconfigToAddMod ::= | SEQUENCE { |

| | |
|---|---|
| zeroOutageCondReconfigId | ZeroOutageCondReconfigId, |

| | |
|---|---|
| zeroOutageCondExecutionCond | SEQUENCE (SIZE (1..2)) OF MeasId |

OPTIONAL, -- Cond condReconfigAdd

| zeroOutageCondRRCReconfig | | OCTET STRING (CONTAINING |
|---|---|---|
| RRCReconfiguration) | OPTIONAL, | -- Cond condReconfigAdd |

| | |
|---|---|
| zeroOutageCHOBeamList | SEQUENCE |

(SIZE(1..maxNrofZeroOutageCHOBeams)) OF ZeroOutageCHO-BeamResource OPTIONAL,
-- Need M
...
}

| | |
|---|---|
| ZeroOutageCHO-BeamResource ::= | CHOICE { |

| | |
|---|---|
| ssb | ZeroOutage-CHO-SSB-Resource, |
| csi-RS | ZeroOutage-CHO-CSIRS-Resource |

}

| | |
|---|---|
| ZeroOutage-CHO-SSB-Resource ::= | SEQUENCE { |

| | |
|---|---|
| ssb | SSB-Index, |
| active-area | ZeroOutage-CHO-BeamMapping, |
| priority | INTEGER (range from Lowest Priority to Highest Priority) |
| ra-PreambleIndex | INTEGER (0..63), |

...
}

| | |
|---|---|
| ZeroOutage-CHO-CSIRS-Resource ::= | SEQUENCE { |

| | |
|---|---|
| csi-RS | NZP-CSI-RS-ResourceId, |
| active-area | ZeroOutage-CHO-BeamMapping, |
| priority | INTEGER (range from Lowest Priority to Highest Priority) |
| ra-OccasionList | SEQUENCE (SIZE(1..maxRA-OccasionsPerCSIRS)) OF |

| | |
|---|---|
| INTEGER (0..maxRA-Occasions-1) | OPTIONAL, -- Need R |

| | |
|---|---|
| ra-PreambleIndex | INTEGER (0..63) |

OPTIONAL, -- Need R
...
}

| | |
|---|---|
| ZeroOutage-CHO-BeamMapping ::= | SEQUENCE { |

| | |
|---|---|
| beam-reference-orientation | Reference-Orientation [in suitable coordinates] |
| beam-start-angle | BEAM-Start-Angle |

| | |
|---|---|
| beam-end-angle | BEAM-End-Angle |
| beam-reference-position | Reference-Position [in suitable coordinates or Zones] |
| beam-Active-SPAN | Active-Span [in suitable geogrphaic coordinates or |

Zones]
...
}

In this example configuration design, CHO candidate cells may be defined and for each CHO cell, beams may be indicated with mapping to geographic coordinates and orientations, effectively providing the mapping of each (cell, beam) pair to geographic coordinates and orientation. In a different approach, the whole design can be made as (cell, beam) candidate pair.

An exemplary embodiment specifying a procedure to have zero outage for a WTRU may undergo conditional handover. The conditional handover may include (1) the WTRU sending the zero outage Assistance Information to the gNB, as shown in 1804 and 1904, (2) The gNB preparing a set of suitable zero outage CHO configuration based upon WTRU assistance information, WTRU profile and the network deployment/configuration and transmitting this set of configurations to the WTRU, (3) the WTRU receiving a zero outage CHO configuration from the gNB, as shown in 1806 and 1906, (4) on a condition when the WTRU is undergoing compromised link quality (serving cell quality going below a configured threshold), the WTRU starts the zero outage conditional handover processing, (5) the WTRU gets the information from local sensors (GPS, Accelerometer, Gyroscope etc.) potentially combined with radio measurements, as shown in 1808 and 1908 (6) the WTRU evaluates the change in local sensors data and configured conditions to determine device mobility or external mobility as per the configuration to determine Device Mobility or External Mobility, as shown in 1810, 1812, 1822, 1910, 1912 and 1922, (7) the WTRU selects the highest priority CHO candidate (cell, beam) among the determined candidates, as shown in 1814, 1914, 1824, and 1924, (8) the WTRU activates the antenna panel associated to the selected CHO candidate, (9) the WTRU evaluates the configured execution conditions for the target CHO candidate, as shown in 1816, 1826 1916, and 1926, and (10) if execution condition gets satisfied, the WTRU performs the conditional CHO to the CHO target cell on the target beam, as shown in 1820, 1830, 1920 and 1930. The zero outage Assistance Information sent to the gNB may include radio-measurement-quantity-based-data, non-radio-measurement-quantity-based-data, and/or WTRU-capability-and-Implementation-details. The zero outage CHO configuration received may include a set of configurations with each configuration indicated for a scenario/condition. Each configuration may include set of CHO candidate (cell, beam) pairs, mapping of each candidate (cell, beam) pair to geographic coordinates and orientation for Device Mobility and External Mobility, and/or priority of (cell, beam) pairs when multiple (cell, beam) pairs may have overlap over geographic zones/orientations. If the WTRU determines Device Mobility, the WTRU may select the Device Mobility CHO configuration. The WTRU may determine the candidate (cell, beam) pairs as selected Candidate from the selected configuration mapping table using its determined geographic coordinates (position/location and orientation etc.) and radio measurements. If the WTRU determines External Mobility, the WTRU may select the External Mobility CHO configuration. The WTRU may determine the candidate (cell, beam) pairs as selected Candidate from the selected configuration mapping table using its determined geographic coordinates (position/location and orientation etc.).

The exemplary embodiment may also include (1) the two sets of conditional handover configurations which are associated to Device Mobility and External Mobility, (2) the sets of CHO configurations which are indicated to be associated to QoS requirements of specific applications/services running at the WTRU device, (3) the sets of CHO configurations which are indicated to be associated to the WTRU power consumption requirements, (4) the sets of CHO configurations which are indicated to be associated to WTRU active subscription, and/or (5) only one unified configuration which is provided to the WTRU.

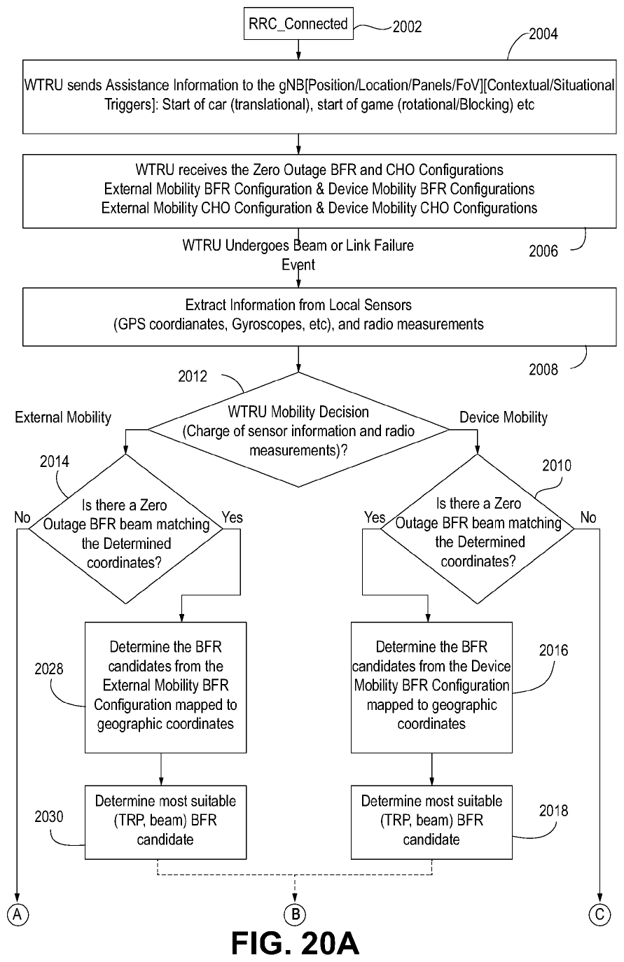

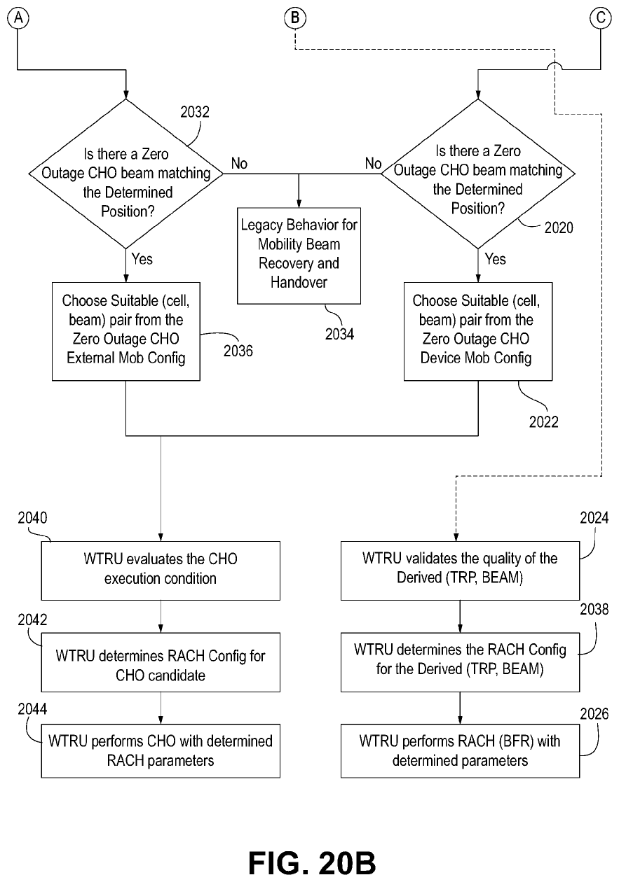

This section may discuss the procedure for the WTRU which has been configured by the network jointly for the zero outage beam recovery and zero outage conditional handover. FIG. 20 shows an example flowchart for a WTRU which has been provided by the network for zero outage BFR and CHO configurations. The WTRU may provide the assistance information to the network. The network may use this assistance information and its known deployment of cells, beams, and the location of TRPs, configures the WTRU with suitable configurations for both zero outage BFR and CHO. These configurations may include the details as outlined in the previous sections.

If the link quality degrades for the target WTRU, it may extract the information from its measurements, interfaces and local sensors to determine its updated geographic coordinates and orientation. This may in addition use the radio measurements to make the estimate more precise robust and granular. With the determined updated coordinates and orientation, the WTRU may first check if there is any suitable zero outage recovery beam. If it finds any suitable recovery beam, it may extract the relevant configured parameters and initiate beam recovery procedure with the derived recovery beam.

This flowchart may show beam recovery (if configured and possible) prioritized over conditional handover. The reason may be that with CHO, the WTRU needs to update the cell configuration which may require configurational changes with respect to the current active cell configuration, and the WTRU has higher impact on the QoS compared to a beam recovery procedure. Despite this flowchart showing beam recovery prior to finding a CHO candidate, a slight variation may be the one where both BFR and CHO configurations are evaluated simultaneously with respect to the WTRU updated determined geographic coordinates and the WTRU takes the most appropriate candidate either from BFR or CHO configurations. The network configuration may also provide priorities for BFR and CHO candidates which can be used by the WTRU to prioritize the suitable subsequent procedure being BFR or CHO.

In the flowchart, if the WTRU does not find any suitable recovery beam, it may check if there is any suitable CHO configuration for the updated position. If the WTRU is configured with a CHO configuration matching its determined coordinates, it may choose the suitable (cell, beam) pair from its selected CHO configuration and initiate the CHO execution if the execution conditions are fulfilled.

If there are multiple candidates specified with priority ordering, the WTRU may try a highest priority candidate first before trying the next highest priority candidate. Multiple candidates with priority indication may be provided for both BFR and CHO procedures.

For the scenarios where zero outage BFR and CHO procedures don't succeed to completion (which may be the result of WTRU not getting the positive response of its BFR recovery transmission, CHO condition not fulfilled, CHO execution failure, or missing CHO/BFR configuration for the WTRU coordinates), the WTRU may resort to legacy beam recovery and handover procedures, and eventually falling back to RRC reestablishment and cell selection procedures.

An exemplary embodiment specifying a procedure to have zero outage for a WTRU undergoing bad radio situations resulting in beam/link failures may comprise the following actions. A WTRU may be in the RRC-Connected mode (2002). Actions may include the WTRU sending the zero outage Assistance Information to the gNB (2004), The gNB preparing multiple configurations for zero outage BFR and zero outage CHO based upon WTRU assistance information, WTRU profile, application/services running at WTRU, WTRU subscription level and the network knowledge of its deployment of cells, beams and transmission nodes, The gNB transmits the sets of configurations to the WTRU, the WTRU receiving zero outage BFR and CHO configurations from the gNB (2006), When the WTRU is undergoing compromised link quality (beam or cell quality going below configured thresholds), the WTRU may start the composite zero outage beam recovery and conditional handover procedure. The WTRU may get information from local sensors (GPS, Accelerometer, Gyroscope etc.) potentially combined with radio measurements (2008). The WTRU may evaluate the change in local sensors data and configured conditions to determine device mobility or external mobility as per the configuration to determine Device/External Mobility (2012). The WTRU may select the Device/External Mobility Beam Recovery configuration (2010, 2014). If the WTRU does not find any suitable beam recovery candidate which correspond to its geographic coordinates and orientation in beam recovery configurations, the WTRU selects the appropriate Device/External Mobility CHO configuration, as shown in 2022, 2024, 2026, 2034, 2036, 2038 2040, and 2042. If the WTRU does not find any suitable CHO candidate which corresponds to its geographic coordinates and orientation in zero outage CHO configurations, the WTRU may fall back to the legacy behavior for beam recovery and (conditional) handover (2024). The zero outage Assistance Information sent to the gNB may include radio-measurement-quantity-based-data, non-radio-measurement-quantity-based-data, and/or WTRU-capability-and-Implementation-details. The zero outage BFR and CHP configurations received may include a set of two zero outage BFR configurations and/or a set of two zero outage CHO configurations. The set of two zero outage BFR configurations may include one configuration associated to Device Mobility and the other to External Mobility. Each configuration in the set of two zero outage BFR configurations may include set of candidate beams/TRPs, candidate beams associated to suitable SSB, CSI-RS or newly designed reference signals, RACH parameters associated to each candidate beam, mapping of candidate TRPs/beams to location/position, orientation for Device Mobility, mapping of candidate TRPs/beams for External Mobility, and/or indication of priority for candidate beams when multiple candidate beams may have at least partial overlap for certain geographic coordinates. The set of two zero outage CHO configurations may include one configuration associated to Device Mobility and the other to External Mobility. Each configuration in the set of two zero outage CHO configurations may include set of CHO candidate (cell, beam) pairs, mapping of each candidate (cell, beam) pair to geographic coordinates and orientation, and/or priority of (cell, beam) pairs when multiple (cell, beam) pairs may have overlap over geographic zones/orientations.

The WTRU may select the Device/External Mobility Beam Recovery configuration may include (1) the WTRU determines the candidate beams as recovery Candidate from the selected configuration mapping table using its determined geographic coordinates (position/location and orientation etc.) and radio measurements, (2) the WTRU selects the highest priority beam among the determined candidates, (3) the WTRU activates the antenna panel associated to the selected BFR candidate, (4) the WTRU measures the quality of the selected BFR candidate beam using the configured measurement signal(s) and the configured threshold(s), (5) On a condition when the selected candidate passes the quality criterion, the WTRU extracts its associated RACH configuration parameters, and/or (6) the WTRU transmits RACH for the BFR candidate using the derived RACH parameters. The WTRU prepares and transmits BFR MAC-CE providing the information of the suitable candidate beam(s) to the network.

The WTRU may select the appropriate Device/External Mobility CHO configuration if the WTRU does not find any suitable beam recovery candidate which correspond to its geographic coordinates and orientation in beam recovery configurations. This may include (1) the WTRU determines the candidate (cell, beam) pairs as selected Candidate from the selected configuration mapping table using its determined geographic coordinates (position/location and orientation etc.) and radio measurements, (2) the WTRU selects the highest priority CHO candidate (cell, beam) among the determined candidates, (3) the WTRU activates the antenna panel associated to the selected CHO candidate, (4) the WTRU evaluates the configured execution conditions for the target CHO candidate, and/or (5) if execution condition gets satisfied, the WTRU performs the conditional CHO to the CHO target cell on the target beam.

The exemplary embodiment may also include (1) the sets of configurations for which BFR/CHO are associated to Device Mobility and External Mobility, (2) the sets of BFR/CHO configurations which are indicated to be associated to QoS requirements of specific applications/services running at the WTRU device, (3) the sets of BFR/CHO configurations which are indicated to be associated to WTRU power consumption requirements, (4) the sets of BFR/CHO configurations are indicated to be associated to WTRU active subscription, (5) only one unified configuration for BFR/CHO which is provided to the WTRU, (6) the BFR and CHO configuration which may indicate priorities with candidates which can be compared across the configurations, and/or (7) the WTRU which may be configured to evaluate BFR and CHO conditions simultaneously.

Although features and elements are provided above in particular combinations, one of ordinary skill in the art may appreciate that each feature or element can be used alone or in any combination with the other features and elements. The present disclosure may not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application may be construed as critical or essential to the invention unless explicitly provided as such. Functionally equivalent methods, apparatuses, and articles of manufacture, within the scope of the disclosure, in addition to those enumerated herein, may be apparent to those skilled in the art from the foregoing descriptions. Such modifications and variations may be intended to fall within the scope of the appended claims. The present disclosure may be limited only by the terms of the appended claims, along with the full scope of equivalents to which such claims are entitled. It may be understood that this disclosure is not limited to particular methods or systems.

Although foregoing embodiments are discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, may not be limited to thereto, and may be applied to other systems that use other forms of electromagnetic waves or non-electromagnetic waves such as acoustic waves, for example.

It may also be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of the WTRU; (iii) a wireless-capable and/or wired-capable (e.g., tetherable) device configured with, inter alia, some or all structures and functionality of the WTRU; (iv) a wireless-capable and/or wired-capable device configured with less than all structures and functionality of the WTRU; or (v) the like. Details of the example WTRU, which are representative of any WTRU recited herein, may be provided herein with respect to FIG. 1A, FIG. 1B, FIG. 1C and FIG. 1D. As another example, various disclosed embodiments herein supra and infra may be described as utilizing a head mounted display. Those skilled in the art may recognize that a device other than the head mounted display is utilized and some or all of the disclosure and various disclosed embodiments are modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media may include electronic signals (transmitted over wired or wireless connections) and computer-readable storage media. Examples of computer-readable storage media, which are differentiated from signals, may include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above may be possible without departing from the scope of the invention. In view of the wide variety of embodiments that can be applied, it may be understood that the illustrated embodiments are examples only, and should not be taken as limiting the scope of the following claims. For instance, embodiments provided herein may include handheld devices, which include or be utilized with any appropriate voltage source, such as a battery or the like, providing any appropriate voltage.

Moreover, in embodiments provided herein, processing platforms, computing systems, controllers, and other devices containing processors may be noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art may appreciate that the acts and symbolically represented operations or instructions include the manipulation of electrical signals by the CPU. An electrical system represents data bits that may cause a resulting transformation or reduction of the electrical signals and the maintenance of data bits at memory locations in a memory system to thereby reconfigure or otherwise alter the CPU's operation, as well as other processing of signals. The memory locations where data bits are maintained may be physical locations that have particular electrical, magnetic, optical, or organic properties corresponding to or representative of the data bits. The embodiments may not be limited to the above-mentioned platforms or CPUs. Other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that are local or remote to the processing system. The embodiments may not be limited to the above-mentioned memories. Other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description may have set forth various embodiments of the devices and/or processes via the use of block diagrams, flowcharts, and/or examples. Insofar as such block diagrams, flowcharts, and/or examples contain one or more functions and/or operations, it may be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art may recognize that some aspects of the embodiments disclosed herein, in whole or in part, are equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware may be well within the skill of one of skill in the art in light of this disclosure. Those skilled in the art may appreciate that the mechanisms of the subject matter described herein are distributed as a program product in a variety of forms, and that an illustrative embodiment of the subject matter described herein applies regardless of the particular type of signal bearing medium used to actually may carry out the distribution. Examples of a signal bearing medium may include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art may recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art may recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter may illustrate different components contained within, or connected with, different other components. It is to be understood that such depicted architectures may merely be examples, and that in fact many other architectures may be implemented which achieve the same functionality. In a conceptual sense, any arrangement of components to achieve the same functionality may be effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable may include but are not limited to physically mateable, and/or physically interacting components, and/or wirelessly interactable, and/or wirelessly interacting components, and/or logically interacting, and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same may hold true for the use of definite articles used to introduce claim recitations. In addition, even if a specific number of an introduced claim recitation is explicitly recited, those skilled in the art may recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction may be intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction may be intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.” Further, the terms “any of” followed by a listing of a plurality of items and/or a plurality of categories of items, as used herein, may be intended to include “any of,” “any combination of,” “any multiple of,” and/or “any combination of multiples of” the items and/or the categories of items, individually or in conjunction with other items and/or other categories of items. Moreover, as used herein, the term “set” may be intended to include any number of items, including zero. Additionally, as used herein, the term “number” may be intended to include any number, including zero. And the term “multiple”, as used herein, may be intended to be synonymous with “a plurality”.

In addition, where features or aspects of the disclosure are described in terms of Markush groups, those skilled in the art may recognize that the disclosure is also thereby described in terms of any individual member or subgroup of members of the Markush group.

As will be understood by one skilled in the art, for any and all purposes, such as in terms of providing a written description, all ranges disclosed herein may encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like may include the number recited and refers to ranges which can be subsequently broken down into subranges as discussed above. Finally, as will be understood by one skilled in the art, a range may include each individual member. Thus, for example, a group having 1-3 cells may refer to groups having 1, 2, or 3 cells. Similarly, a group having 1-5 cells may refer to groups having 1, 2, 3, 4, or 5 cells, and so forth.

What is claimed is:

1-20. (canceled)

21. A wireless transmit/receive unit (WTRU) comprising:
a transceiver and processor, the processor configured to:
receive, via the transceiver, a beam recovery configuration, wherein the beam recovery configuration comprises:
an indication of at least one candidate beam;
respective reference signal information associated with each candidate beam of the at least one candidate beam;
respective quality criterion and random access transmission parameters associated with each candidate beam; and
respective information associated with each candidate beam of the at least one candidate beam, wherein the respective information comprises an indication of at least one area of coverage associated with a respective candidate beam of the at least one candidate beam;
detect a beam failure condition has been met; and
select at least one candidate beam of the at least one candidate beam based at least on the beam failure condition being met, local sensor data, and the respective area of coverage associated with the selected at least one candidate beam; and
on a condition when the selected candidate beam passes the quality criterion, determine the random access transmission parameters associated to the selected candidate beam based on the random access transmission parameters; and
transmit a random access channel (RACH) transmission to the selected candidate beam according to the determined random access transmission parameters.

22. The WTRU of claim 21, wherein the processor is configured to send, via the transceiver, an indication that the WTRU is capable of using the local sensor data for beam failure recovery.

23. The WTRU of claim 21, wherein the beam recovery configuration further comprises a priority associated with each candidate beam of the at least one candidate beam.

24. The WTRU of claim 23, wherein the processor is configured to select the at least one candidate beam based on the priority associated with each candidate beam of the at least one candidate beam.

25. The WTRU of claim 24, wherein the processor is configured to determine beam priority by mapping the network configured mapping to the WTRU's estimated geographic coordinates and orientation.

26. The WTRU of claim 21, wherein the processor is configured to select the at least one candidate beam based on the respective reference signal information associated with each candidate beam of the at least one candidate beam.

27. The WTRU of claim 21, wherein the reference signal information comprises at least one of channel state information reference signal information or random access channel information.

28. The WTRU of claim 21, wherein the information associated with each candidate beam of the at least one candidate beam comprises any combination of global positioning system information, gyroscopic information, or accelerometer information.

29. The WTRU of claim 21, wherein the processor is configured to provide assistance information to the network to prompt the network to send the beam recovery configuration.

30. The WTRU of claim 29, wherein the assistance information comprises measurement-based data and non-measurement-based data.

31. A method implemented in a wireless transmit/receive unit (WTRU), the method comprising:
receiving a beam recovery configuration, wherein the beam recovery configuration comprises:
an indication of at least one candidate beam;
respective reference signal information associated with each candidate beam of the at least one candidate beam;
respective quality criterion and random access transmission parameters associated with each candidate beam; and
respective information associated with each candidate beam of the at least one candidate beam, wherein the respective information comprises an indication of at least one area of coverage associated with a respective candidate beam of the at least one candidate beam;
detecting a beam failure condition has been met; and
selecting at least one candidate beam of the at least one candidate beam based at least on the beam failure condition being met, local sensor data, and the respective area of coverage associated with the selected at least one candidate beam; and
on a condition when the selected candidate beam passes the quality criterion, determining the random access transmission parameters associated to the selected candidate beam based on the random access transmission parameters; and
transmitting a random access channel (RACH) transmission to the selected candidate beam according to the determined random access transmission parameters.

32. The method of claim 31, further comprising sending an indication that the WTRU is capable of using the local sensor data for beam failure recovery.

33. The method of claim 31, wherein the beam recovery configuration further comprises a priority associated with each candidate beam of the at least one candidate beam.

34. The method of claim 33, further comprising selecting the at least one candidate beam based on the priority associated with each candidate beam of the at least one candidate beam.

35. The method of claim 34, further comprising determining beam priority by mapping the network configured mapping to the WTRU's estimated geographic coordinates and orientation.

36. The method of claim 31, further comprising selecting the at least one candidate beam based on the respective reference signal information associated with each candidate beam of the at least one candidate beam.

37. The method of claim 31, wherein the reference signal information comprises at least one of channel state information reference signal information or random access channel information.

38. The method of claim 31, wherein the information associated with each candidate beam of the at least one candidate beam comprises any combination of global positioning system information, gyroscopic information, or accelerometer information.

39. The method of claim 31, further comprising providing assistance information to the network to prompt the network to send the beam recovery configuration.

40. The method of claim 39, wherein the assistance information comprises measurement-based data and non-measurement-based data.
